(19) United States
(12) Patent Application Publication
(10) Pub. No.: US 2011/0120937 A1
(43) Pub. Date: May 26, 2011

(54) FILTRATION FILTER AND METHOD FOR PRODUCING THE SAME

(75) Inventors: Kenichi ISHIZUKA, Kanagawa (JP); Nobuhiro NISHITA, Kanagawa (JP)

(73) Assignee: FUJIFILM CORPORATION, Tokyo (JP)

(21) Appl. No.: 12/954,314

(22) Filed: Nov. 24, 2010

(30) Foreign Application Priority Data
Nov. 25, 2009 (JP) 2009-267697

(51) Int. Cl. B01D 71/36; B01D 39/16; B01D 71/06; B29D 7/01

(52) U.S. Cl. 210/493.1; 210/500.27; 210/500.37; 210/500.42; 210/500.36; 264/45.8

(57) ABSTRACT

A filtration filter including a cartridge, which contains a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof, wherein at least part of the crystalline polymer microporous membrane forming the cartridge is subjected to surface modification after the crystalline polymer microporous membrane is formed into the cartridge.

### BACKGROUND OF THE INVENTION

1. Field of the Invention

The present invention relates to a filtration filter which has high filtration efficiency and is used for precise filtration of gases, liquids and the like, and to a method for producing the filtration filter.

2. Description of the Related Art

Microporous membranes have long since been known and widely used for filtration filters, etc. As such microporous membranes, there are, for example, a microporous membrane using cellulose ester as a material thereof (see U.S. Pat. No. 1,421,341), a microporous membrane using aliphatic polyamide as a material thereof (see U.S. Pat. No. 2,783,894), a microporous membrane using polyfluorocarbon as a material thereof (see U.S. Pat. No. 4,196,070), a microporous membrane using polypropylene as a material thereof (see West German Patent No. 3,003,400), and the like.

These microporous membranes are used for filtration and sterilization of washing water for use in the electronics industries, water for medical use, water for pharmaceutical production processes and water for use in the food industry. In recent years, the applications of and amount for using microporous membranes have increased, and microporous membranes have attracted great attention because of their high reliability in trapping particles. Among them, microporous membranes made of crystalline polymers are superior in chemical resistance, and in particular, microporous membranes produced by using polytetrafluoroethylene (PTEF) as a raw material are superior in both heat resistance and chemical resistance. Therefore, demands for such microporous membranes have been rapidly growing.

Generally speaking, microporous membranes have a low filtration flow rate (i.e., a short lifetime) per unit area. In the case where the microporous membranes are used for industrial purposes, it is necessary to align many filtering units to increase the membrane areas. For this reason, a reduction in the cost for the filtering process is appreciated, and thus an extension of the filtering lifetime is desired. To this end, there are various proposals for a microporous membrane effective for preventing or slowing down reductions in flow rate due to clogging, such as an asymmetric membrane in which pore diameters are gradually reduced from the inlet side to the outlet side.

Moreover, another proposal is a microporous membrane of a crystalline polymer, which has a larger average pore diameter on a surface of the membrane than that on the back surface thereof, and has the pores whose average diameter continuously changes from the surface to the back surface (see Japanese Patent Application Laid-Open (JP-A) No. 2007-332342). According to this proposal, fine particles are efficiently captured by the filter and the lifetime of the filter is improved, by performing filtration using, as the inlet side, the plane (i.e. the surface) having the larger average pore diameter.

As a hydrophilization treatment method of a crystalline polymer microporous membrane having an asymmetric pore structure, a method proposed in JP-A No. 2009-119412 is that an exposed surface of the crystalline polymer microporous membrane having an asymmetric pore structure is subjected to hydrophilic treatment by impregnation of aqueous solution of hydrogen peroxide or water-soluble solvent, laser irradiation, or chemical etching. However, JP-A No. 2009-119412 does not disclose nor suggest that the crystalline polymer microporous membrane formed into a cartridge is subjected to hydrophilic treatment so that porosity is maintained and high flow rate and long life time of the membrane can be achieved since the hydrophilic treatment to the cartridge prevents thermal shrinkage of the membrane upon the surface modification, and fusion of fibril.

A method disclosed in JP-A No. 2003-514644 is immobilizing three ligands (SL 415, SL 420 and SL 407; ligands suitable for removing a plurality of different ions (paragraph [0018]) on one cartridge containing a pleated membrane of hydrophilic polyethylene (see Example 1). Moreover, an aqueous solution containing Cu is purified through a pleated cartridge made with the ligand (SL 420)-immobilized membrane, consequently, Cu concentration is decreased from 100 ppb to 0.001 ppb or less (Example 3).

However, according to the method disclosed in JP-A No. 2003-514644, when the cartridge containing a pleated membrane of hydrophilic polyethylene is subjected to surface modification, a surface modifying agent is localized only in the pleated portions, and is not sufficiently applied to the plane portions, which causes insufficient surface modification at the plane portions. Thus, when water is filtrated through the resulting cartridge, flow rate was low and the life time of the cartridge is short. Since the disclosed cartridge is not a cartridge formed of the crystalline polymer microporous membrane having asymmetric pores, and acrylates are mainly used as the surface modifying agent, there is a problem of poor alkali resistance and acid resistance.

A method for producing a cartridge filter proposed in JP-A No. 04-029729 is that a porous membrane formed of a fluororesin is fused to a molded product of hydrophobic polymer having a melting point lower than that of the fluororesin, and then a hydrophilic material is fixed thereon. The method described in Example 1 of JP-A No. 04-029729 includes immersion of a fluoroguard cartridge (manufactured by Nihon Millipore K.K.) formed of a PTFE porous membrane in a PVA aqueous solution.

However, this proposal does not provide a cartridge formed of the crystalline polymer microporous membrane having asymmetric pores, and has a problem of non-uniformity that a surface modifying agent is localized only in pleated portions and plane portions are not sufficiently surface modified. There is also a problem such that a large device is required for the production, since γ line is used for surface modification.

A method for producing a polysulfone microporous membrane proposed in JP-A No. 63-277251 includes a step of casting, on a support, a solution obtained by dissolving polysulfone or polyether sulfone, and a swelling agent in a solvent, and immersing the support in a coagulation bath, and immersing the obtained microporous membrane in an aqueous solution of polyoxyethylene surfactant, followed by drying the microporous membrane by high-frequency electric drying.

This proposal does not provide a cartridge formed of the crystalline polymer microporous membrane having asymmetric pores. Although the non-uniformity of the surface modification is improved by immersing the membrane, the following high-frequency electric drying thereof can only evaporate the solvent, but the high-frequency electric drying cannot sufficiently perform crosslinking reaction

Accordingly, there is currently a demand for a filtration filter having high water resistance, high acid resistance, high chemical resistance, high alkali resistance, high hydrophilicity, long lifetime, and excellent filtration flow rate, which is attained by subjecting a crystalline polymer microporous membrane having an asymmetric pore structure to surface modification after the crystalline polymer microporous membrane is formed into a cartridge, so as to secure porosity, and a method for producing a filtration filter.

### BRIEF SUMMARY OF THE INVENTION

An object of the present invention is to provide a filtration filter having high water resistance, high acid resistance, high chemical resistance, high alkali resistance, high hydrophilicity, long lifetime, and excellent filtration flow rate, which is attained by subjecting a crystalline polymer microporous membrane having an asymmetric pore structure to surface modification after the crystalline polymer microporous membrane is formed into a cartridge, so as to secure porosity, and a method for producing a filtration filter.

To solve the above problems the inventors of the present invention have intensively studied and found that porosity of a crystalline polymer microporous membrane can be secured and high flow rate and long life time of the filtration filter can be achieved since the crystalline polymer microporous membrane is formed into a cartridge, and then subjected to surface modification so as to prevent thermal shrinkage of the membrane upon surface modification, and fusion of fibril.

Moreover, they have found that since the crystalline polymer microporous membrane has an asymmetric pore structure, a surface modifying agent easily physically adsorbs on the crystalline polymer microporous membrane, localization of the surface modifying agent on pleated portions, which has been conventionally a problem, can be prevented and uniform surface modification can easily perform.

### Means for Solving the Aforementioned Problems are as Follows

<1> A filtration filter containing: a cartridge, which contains a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof, wherein at least part of the crystalline polymer microporous membrane forming the cartridge is subjected to surface modification after the crystalline polymer microporous membrane is formed into the cartridge.
<2> The filtration filter according to <1>, further containing any one of a crosslinking material and a polymer material, which covers at least part of the crystalline polymer microporous membrane for the surface modification.
<3> The filtration filter according to <2>, wherein the crosslinking material is one selected from the group consisting of a hydrophilic polymer, a surfactant, polyhydric alcohol, polyamine and fluorine alcohol.
<4> The filtration filter according to <3>, wherein the crosslinking material is crosslinked using a crosslinking agent.
<5> The filtration filter according to <2>, wherein the polymer material is one selected from the group consisting of a cationic polymer, a vinyl acetate polymer, an ethylene oxide polymer, and a vinyl compound.
<6> The filtration filter according to any one of <1> to <5>, wherein the crystalline polymer microporous membrane satisfies: (d₃′/d₄′)/(d₃/d₄)>1, where d₃ and d₄ respectively denote the average pore diameter of the first surface of the crystalline polymer microporous membrane formed into the cartridge before surface modification, and the average pore diameter of the second surface of the crystalline polymer microporous membrane formed into the cartridge before surface modification, d₃′ and d₄′ respectively denote the average pore diameter of the first surface of the crystalline polymer microporous membrane formed into the cartridge after surface modification, and the average pore diameter of the second surface of the crystalline polymer microporous membrane formed into the cartridge after surface modification, d₃/d₄ expresses a ratio of d₃ to d₄, d₃′/d₄′ expresses a ratio of d₃′ to d₄′.
<7> The filtration filter according to any one of <1> to <6>, wherein the crystalline polymer microporous membrane contains a crystalline polymer, which is at least one selected from the group consisting of polytetrafluoroethylene, polyvinylidene fluoride, a tetrafluoroethylene-perfluoroalkylvinyl ether copolymer, a tetrafluoroethylene-hexafluoropropylene copolymer, a tetrafluoroethylene-ethylene copolymer, polychlorotrifluoroethylene, a chlorotrifluoroethylene-ethylene copolymer, polyethylene, polypropylene, nylon, polyacetal, polybutylene terephthalate, polyethylene terephthalate, syndiotactic polystyrene, polyphenylene sulfide, polyether ether ketone, wholly aromatic polyamide, wholly aromatic polyester, and polyethernitrile.
<8> The filtration filter according to any one of <1> to <7>, wherein the crystalline polymer microporous membrane contains the crystalline polymer, which is polytetrafluoroethylene.
<9> The filtration filter according to any one of <1> to <8>, wherein the cartridge is a pleated cartridge.
<10> A method for producing a filtration filter including: forming a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof; forming the crystalline polymer microporous membrane into a cartridge; and subjecting at least part of the crystalline polymer microporous membrane formed into the cartridge to surface modification.
<11> The method for producing a filtration filter according to <10>, wherein the cartridge is a pleated cartridge.
<12> The method for producing a filtration filter according to any one of <10> to <11>, wherein the surface modification contains covering at least part of the crystalline polymer microporous membrane with any one of a crosslinking material and a polymer material.
<13> The method for producing a filtration filter according to any one of <10> to <12>, wherein the crystalline polymer microporous membrane contains a crystalline polymer, which is at least one selected from the group consisting of polytetrafluoroethylene, polyvinylidene fluoride, a tetrafluoroethylene-perfluoroalkylvinyl ether copolymer, a tetrafluoroethylene-hexafluoropropylene copolymer, a tetrafluoroethylene-ethylene copolymer, polychlorotrifluoroethylene, a chlorotrifluoroethylene-ethylene copolymer, polyethylene, polypropylene, nylon, polyacetal, polybutylene terephthalate, polyethylene terephthalate, syndiotactic polystyrene, polyphenylene sulfide, polyether ether ketone, wholly aromatic polyamide, wholly aromatic polyester, and polyethernitrile.
<14> The method for producing a filtration filter according to any one of <10> to <13>, wherein the crystalline polymer microporous membrane contains the crystalline polymer, which is polytetrafluoroethylene.

The present invention solves the aforementioned various problems in the art, and can provide a filtration filter having high water resistance, high acid resistance, high chemical resistance, high alkali resistance, high hydrophilicity, long lifetime, and excellent filtration flow rate, and a method for producing a filtration filter.

### BRIEF DESCRIPTION OF THE DRAWINGS

FIG. 1 is a view illustrating the structure of an ordinary pleated filter element before mounted in a housing.

FIG. 2 is a view illustrating the structure of an ordinary filter element before mounted in a housing of a capsule-type cartridge.

FIG. 3 is a view illustrating a structure of an ordinary capsule-type cartridge formed integrally with a housing.

FIG. 4A is a schematic view illustrating a cross-section of the crystalline polymer microporous membrane having a symmetric pore structure of Comparative Example 3, before being subjected to surface modification.

FIG. 4B is a schematic view illustrating a cross-section of the crystalline polymer microporous membrane having a symmetric pore structure of Comparative Example 3, after being subjected to surface modification.

FIG. 5A is a schematic view illustrating a cross-section of the crystalline polymer microporous membrane having an asymmetric pore structure of Example 1, before being subjected to surface modification.

FIG. 5B is a schematic view illustrating a cross-section of the crystalline polymer microporous membrane having an asymmetric pore structure of Example 1 after being subjected to surface modification.

### DETAILED DESCRIPTION OF THE INVENTION

### Filtration Filter and Method for Producing Filtration Filter

A filtration filter of the present invention includes a cartridge, which contains a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof, and further includes other members as necessary.

The method for producing a filtration filter of the present invention includes a crystalline polymer microporous membrane forming step, a cartridge forming step, a surface modification step, and may further contain and other steps, if necessary.

The filtration filter and the method for producing the same of the present invention will be specifically explained hereinafter.

In the present invention, at least part of a crystalline polymer microporous membrane forming the cartridge is subjected to surface modification, after the crystalline polymer microporous membrane is formed into the cartridge.

Here, “a crystalline polymer microporous membrane forming the cartridge is subjected to surface modification, after the crystalline polymer microporous membrane is formed into the cartridge” means that a crystalline polymer microporous membrane which has been formed into a cartridge is subjected to surface modification. The specific content of “forming the crystalline polymer microporous membrane into the cartridge” and method of the surface modification will be described in a method for producing a filtration filter.

### <Crystalline Polymer Microporous Membrane>

A crystalline polymer microporous membrane used in the present invention is obtained by heating one surface of a film formed of a crystalline polymer to form a semi-baked film with a temperature gradient in the thickness direction thereof, drawing the semi-baked film.

In this case, it is preferred that heating be performed from the side of “the second surface” having the smaller average pore diameter than that on the “first surface.”

The pore is a continuous pore (i.e. a pore both ends of which are open) from the first surface to the second surface.

The “first surface” having the larger average pore diameter may be referred to as “unheated surface,” and “the second surface” having the smaller average pore diameter may be referred to as “the heated surface” in the descriptions below for simplicity of explanation. However, semi-baking may be performed on either surface of an unbaked crystalline polymer film, and thus either surface thereof may become “the heated surface.”

### <<Crystalline Polymer>>

In the present specification, the term “crystalline polymer” means a polymer having a molecular structure in which crystalline regions containing regularly-aligned long-chain molecules are mixed with amorphous regions having not regularly aligned long-chain molecules. Such polymer exhibits crystallinity through a physical treatment. For example, if a polyethylene film is drawn by an external force, a phenomenon is observed in which the initially transparent film turns to the clouded film in white. This phenomenon is derived from the expression of crystallinity which is obtained when the molecular alignment in the polymer is aligned in one direction by the external force.

The crystalline polymer is suitably selected depending on the intended purpose without any restriction. Examples thereof include polyalkylenes, polyesters, polyamides, polyethers, and liquid crystalline polymers. Specific examples thereof include polytetrafluoroethylene, polyvinylidene fluoride, a tetrafluoroethylene-perfluoroalkylvinyl ether copolymer, a tetrafluoroethylene-hexafluoropropylene copolymer, a tetrafluoroethylene-ethylene copolymer, polychlorotrifluoroethylene, a chlorotrifluoroethylene-ethylene copolymer, polyethylene, polypropylene, nylon, polyacetal, polybutylene terephthalate, polyethylene terephthalate, syndiotactic polystyrene, polyphenylene sulfide, polyether ether ketone, wholly aromatic polyamide, wholly aromatic polyester, fluororesin, and polyethernitrile. These may be used independently or in combination.

Among them, polyalkylene (e.g. polyethylene and popypropylene) is preferable, fluoropolyalkylenes in which a hydrogen atom of the alkylene group in polyalkylene is partially or wholly substituted with a fluorine atom are more preferable, and polytetrafluoroethylenes (PTFE) are particularly preferable, as they have desirable chemical resistance and handling properties.

Polyethylenes vary in their densities depending on the branching degrees thereof and are classified into low-density polyethylenes (LDPE) that have high branching degrees and are low in crystallinity, and high-density polyethylenes (HDPE) that have low branching degrees and are high in crystallinity. Both LDPE and HDPE can be used. Among them, HDPE is particularly preferable in terms of the crystallinity control.

The crystalline polymer preferably has a glass transition temperature of 40° C. to 400° C., more preferably 50° C. to 350° C. The crystalline polymer preferably has a mass average molecular weight of 1,000 to 100,000,000. The crystalline polymer preferably has a number average molecular weight of 500 to 50,000,000, more preferably 1,000 to 10,000,000.

The crystalline polymer microporous membrane has a plurality of pores, where the average pore diameter of an unheated surface (first surface) of the crystalline polymer microporous membrane is larger than that of a heated surface (second surface) thereof.

When the crystalline polymer microporous membrane is assumed to have a thickness of 10, an average pore diameter is P1 at a depth of 1 from the surface, an average pore diameter is P2 at a depth of 9 from the surface, and the ratio P1/P2 is preferably 2 to 10,000, more preferably 3 to 100.

In addition, the crystalline polymer microporous membrane has a ratio (an average pore diameter at the unheated surface/an average pore diameter at the heated surface) of 5/1 to 30/1, more preferably 10/1 to 25/1, and even more preferably 15/1 to 20/1.

The average pore diameter of the unheated surface (first surface) of the crystalline polymer microporous membrane is suitably selected depending on the intended purpose without any restriction, but it is preferably 0.1 μm to 500 μm, more preferably 0.25 μm to 250 μm, and particularly preferably 0.50 μm to 100 μm.

When the average pore diameter is smaller than 0.1 μm, the flow rate may be reduced. When the average pore diameter is larger than 500 μm, fine particles may not be efficiently captured. On the other hand, the average pore diameter within the above-described particularly preferable range is advantageous for the flow rate and capturing ability of fine particles.

The average pore diameter of the heated surface (second surface) of the crystalline polymer microporous membrane is suitably selected depending on the intended purpose without any restriction, but it is preferably 0.01 μm to 5.0 μm, more preferably 0.025 μm to 2.5 μm, and particularly preferably 0.05 μm to 1.0 μm.

When the average pore diameter is smaller than 0.01 μm, the flow rate may be reduced. When the average pore diameter is larger than 5.0 μm, fine particles may not be efficiently captured. On the other hand, the average pore diameter within the above-described particularly preferable range is advantageous for the flow rate and capturing ability of fine particles.

The average pore diameter is, for example, measured as follows: a surface of the membrane is photographed (SEM photograph with a magnification of ×1,000 to ×5,000) using a scanning electron microscope (HITACHI S-4000, and HITACHI E1030 (for vapor deposition), both manufactured by Hitachi, Ltd.), the photograph is taken into an image processing apparatus (Name of main body: TV IMAGE PROCESSOR TVIP-4100II, manufactured by Nippon Avionics Co., Ltd., Name of control software: TV IMAGE PROCESSOR IMAGE COMMAND 4198, manufactured by Ratoc System Engineering Co., Ltd.) so as to obtain an image only including crystalline polymer fibers, a certain number of pores on the image were measured in terms of the diameter thereof, and the average pore diameter is calculated by arithmetically processing the measured pores.

The crystalline polymer microporous membrane of the present invention includes both an (first) aspect in which the average pore diameter continuously changes from the unheated surface (the first surface) thereof towards the heated surface (the second surface) thereof, and an (second) aspect in which the membrane has a single-layer structure. Addition of these aspects makes it possible to lengthen the filtration lifetime effectively.

The phrase “the average pore diameter continuously changes from the unheated surface thereof towards the heated surface thereof” used in the first aspect means that when the distance (t) from the unheated surface in the thickness direction (which is equivalent to the depth from the first surface) is plotted on the horizontal axis on a graph, and the average pore diameter (D) is plotted on the vertical axis on the graph, the graph is represented by one continuous line. The graph concerning the area between the unheated surface (t=0) and the heated surface (t=membrane thickness) may be composed only of regions where the inclination is negative (dD/dt<0), or may be composed of regions where the inclination is negative and regions where the inclination is zero (dD/dt=0), or may be composed of regions where the inclination is negative and regions where the inclination is positive (dD/dt>0). It is desirable that the graph be composed only of regions where the inclination is negative (dD/dt<0), or composed of regions where the inclination is negative and regions where the inclination is zero (dD/dt=0). It is particularly desirable that the graph be composed only of regions where the inclination is negative (dD/dt<0).

The regions where the inclination is negative preferably include at least the unheated surface of the membrane. In the regions where the inclination is negative (dD/dt<0), the inclination may be constant or vary. For instance, when the graph concerning the crystalline polymer microporous membrane of the present invention is composed only of regions where the inclination is negative (dD/dt<0), it is possible to employ an aspect in which dD/dt at the heated surface of the membrane is greater than dD/dt at the unheated surface of the membrane. Also, it is possible to employ an aspect in which dD/dt gradually increases from the unheated surface of the membrane towards the heated surface of the membrane (an aspect in which the absolute value thereof decreases).

The term “single-layer structure” used in the second aspect excludes multilayer structures which are each formed, for example, by sticking together or depositing two or more layers. In other words, the term “single-layer structure” used in the second aspect means a structure having no border between layers that exists in a multilayer structure. In the second aspect, it is preferred that the membrane have a plane, where the average pore diameter is smaller than that at the unheated surface and larger than that at the heated surface, inside the membrane.

The crystalline polymer microporous membrane of the present invention preferably includes both the characteristics of the first and second aspects. Specifically, the microporous membrane is preferably such that the average pore diameter at the unheated surface of the membrane is larger than the average pore diameter at the heated surface of the membrane, the average pore diameter continuously changes from the unheated surface towards the heated surface, and the membrane has a single-layer structure. Configuration in such a manner makes it possible for the microporous membrane to trap fine particles highly efficiently when a solution or the like is passed for filtration from the side of the surface with the larger average pore diameter, enables its filtration lifetime to lengthen greatly and can be produced easily at low cost.

A thickness of the crystalline polymer microporous membrane is preferably 1 μm to 300 μm, more preferably 5 μm to 100 μm, and even more preferably 10 μm to 80 μm.

### <Method for Producing Crystalline Polymer Microporous Membrane>

A method for producing a crystalline polymer microporous membrane used in the present invention contains at least an asymmetric heating step and a drawing step, and may further contain a crystalline polymer film forming step, and other steps, if necessary.

### <<Crystalline Polymer Film Forming Step>>

A starting material used for forming an unbaked crystalline film formed of a crystalline polymer is suitably selected from those crystalline polymers mentioned above without any restriction. Among them, polyethylene, or a crystalline polymer in which hydrogen atoms of polyethylene are replaced with fluorine atoms is suitably used, and polytetrafluoroethylene (PTFE) is particularly preferably used.

The crystalline polymer used as the starting material preferably has a number average molecular weight of 500 to 50,000,000, more preferably 1,000 to 10,000,000.

The crystalline polymer used as the starting material is preferably polyethylene, such as polytetrafluoroethylene. As polytetrafluoroethylene, those produced by emulsification polymerization can be used. Preferably, fine polytetrafluoroethylene powder obtained by coagulating aqueous dispersed elements obtained from the emulsification polymerization is used.

Polytetrafluoroethylene used as the starting material preferably has a number average molecular weight of 2,500,000 to 10,000,000, more preferably 3,000,000 to 8,000,000.

A starting material of polytetrafluoroethylene is suitably selected from those known in the art without any restriction, and can be selected from the commercially available starting materials thereof. Preferable examples of the commercial product thereof include POLYFLON fine powder F104U, manufactured by DAIKIN INDUSTRIES, LTD.

It is preferred that a film be prepared by mixing the starting material of polytetrafluoroethylene and an extrusion aid, subjecting the mixture to paste extrusion and drawing the mixture under pressure. The extrusion aid is preferably a liquid lubricant, and specific examples thereof include solvent naphtha and white oil. A commercially available product may be used as the extrusion aid, for example a hydrocarbon oil such as ISOPAR produced by Esso Sekiyu K. K. The amount of the extrusion aid to be added is preferably in the range of 20 parts by mass to 30 parts by mass relative to 100 parts by mass of the crystalline polymer.

In general, the paste extrusion is preferably carried out at a temperature of 50° C. to 80° C. The shape into which the mixture is extruded is suitably selected depending on the intended purpose without any restriction, but the mixture is preferably extruded into a rod. The extruded matter is subsequently drawn into a film under pressure. The drawing under pressure may, for example, be performed by calendering at a rate of 50 m/min, using a calender roll. The temperature at which the drawing under pressure is performed is generally set at 50° C. to 70° C. Thereafter, the film is preferably heated so as to remove the extrusion aid and thus to form an unbaked crystalline polymer film. The heating temperature at this time is suitably set depending on the crystalline polymer for use, but is preferably 40° C. to 400° C., more preferably 60° C. to 350° C. When polytetrafluoroethylene is used as the crystalline polymer, for example, the heating temperature is preferably 150° C. to 280° C., more preferably 200° C. to 255° C. The heating may be performed, for example, by placing the film in a hot-air drying oven. The thickness of the unbaked crystalline polymer film thus produced may be suitably adjusted depending on the thickness of the crystalline polymer microporous membrane to be produced as a final product, and it is also necessary to adjust the thickness under the consideration of reduction in thickness caused by drawing in a subsequent step.

For the production of the crystalline polymer unheated film, the descriptions in “Polyflon Handbook” (published by DAIKIN INDUSTRIES, LTD., Revised Edition of the year 1983) may be suitably used as a reference, and applied.

### <<Asymmetric Heating Step>>

The asymmetric heating step is heating one surface of a film formed of the crystalline polymer with a temperature gradient in the film thickness direction so as to form a semi-baked film.

Here, the term “semi-baked” means that the crystalline polymer is heated at a temperature equal to or higher than the melting point of the baked crystalline polymer, and equal to or lower than the melting point of the unbaked crystalline polymer plus 15° C.

Moreover, the term “unbaked crystalline polymer” means a crystalline polymer which has not been heated for baking, and the term “the melting point of the crystalline polymer” means a peak temperature on an endothermic curve which is formed when the calorific value of the unbaked crystalline polymer is measured by a differential scanning calorimeter. The melting points of the baked and unbaked crystalline polymers vary depending on the crystalline polymer for use or an average molecular weight thereof, but are preferably 50° C. to 450° C., more preferably 80° C. to 400° C.

The selection of such temperature range is based upon the following. In the case of polytetrafluoroethylene, for example, the melting point of baked polytetrafluoroethylene is approximately 324° C. and the melting point of unbaked polytetrafluoroethylene is approximately 345° C. Accordingly, to produce a semi-baked film from the polytetrafluoroethylene film, the film is preferably heated at a temperature of 327° C. to 360° C., more preferably 335° C. to 350° C., and for example at 345° C. The semi-baked film is in the state where a film having a melting point of approximately 324° C. coexists with a film having a melting point of approximately 345° C.

The semi-baked film is produced by heating the one surface (a heating surface) of the film formed of a crystalline polymer. This makes it possible to control the heating temperature in an asymmetrical manner in the thickness direction and to produce a crystalline polymer microporous membrane easily.

As for the temperature gradient in the thickness direction of the film, the temperature difference between the heating surface and unheating surface of the film is preferably 30° C. or more, more preferably 50° C. or more.

The method of heating the film is selected from the various methods, such as a method of blowing hot air to the crystalline polymer film, a method of bringing the crystalline polymer film into contact with a heat medium, a method of bringing the crystalline polymer film into contact with a heated member, a method of irradiating the crystalline polymer film with an infrared ray and a method of irradiating the crystalline polymer film with an electromagnetic wave.

Although the method of heating the film can be selected without any restriction, the method of bringing the crystalline polymer film into contact with a heated member and the method of irradiating the crystalline polymer film with an infrared ray are particularly preferable. As the heated member, a heating roller is particularly preferable. Use of the heating roller makes it possible to continuously perform semi-baking in an assembly-line operation in an industrial manner similarly to heating the heating surface and makes it easier to control the temperature and maintain the apparatus. The temperature of the heating roller can be set at the temperature for performing the semi-baking. The duration for the contact between the heating roller and the film may be long enough to sufficiently perform the intended semi-baking, and is preferably 30 seconds to 120 seconds, more preferably 45 seconds to 90 seconds, and even more preferably 60 seconds to 80 seconds.

The method of the infrared ray irradiation is suitably selected from those known in the art without any restriction.

For the general definition of the infrared ray, “Infrared Ray in Practical Use” (published by Ningentorekishisha in 1992) may be referred to. Here, the infrared ray means an electromagnetic wave having a wavelength of 0.74 μm to 1,000 μm. Within this range, an electromagnetic wave having a wavelength of 0.74 μm to 3 μm is defined as a near-infrared ray, and an electromagnetic wave having a wavelength of 3 μm to 1,000 μm is defined as a far-infrared ray.

Since the temperature difference between the unheated surface and the heated surface of the semi-baked film is preferably large, it is desirable to use a far-infrared ray that is advantageous for heating a surface layer.

A device for applying the infrared ray is suitably selected depending on the intended purpose without any restriction, provided that it can apply an infrared ray having a desired wavelength. Generally, an electric bulb (halogen lamp) is used as a device for applying the near-infrared ray, while a heating element such as a metal oxidized surface, quartz or ceramic is used as a device for applying the far-infrared ray.

Also, infrared irradiation enables the film to be continuously semi-baked in an assembly-line operation in an industrial manner and makes it easier to control the temperature and maintain the device. Moreover, since the infrared irradiation is performed in a noncontact manner, it is clean and does not allow defects such as pilling to arise.

The temperature of the film surface when irradiated with the infrared ray can be controlled by the output of the infrared irradiation device, the distance between the infrared irradiation device and the film surface, the irradiation time (conveyance speed) and/or the atmospheric temperature, and may be adjusted to the temperature at which the film is semi-baked. The temperature of the film surface is preferably 327° C. to 380° C., more preferably 335° C. to 360° C. When the temperature is lower than 327° C., the crystallized state may not change and thus the pore diameter may not be able to be controlled. When the temperature is higher than 380° C., the entire film may melt, thus possibly causing extreme deformation or thermal decomposition of the polymer.

The duration for the infrared irradiation is suitably adjusted depending on the intended purpose without any restriction, but is long enough to perform sufficient semi-baking, preferably 30 seconds to 120 seconds, more preferably 45 seconds to 90 seconds, and even more preferably 60 seconds to 80 seconds.

The heating in the asymmetric heating step may be carried out continuously or intermittently.

In the case where the second surface of the film is continuously heated, it is preferable to simultaneously perform heating of the second surface and cooling of the first surface of the film to maintain the temperature gradient of the film between the first surface and second surface.

The method of cooling the first surface (unheated surface) is suitably selected depending on the intended purpose without any restriction. Examples thereof include a method of blowing cold air, a method of bringing the unheated surface into contact with a cooling medium, a method of bringing the unheated surface into contact with a cooled material and a method of cooling the unheated surface by cooling in air. It is preferred that the cooling be performed by bringing the unheated surface into contact with the cooled material. A cooling roller is particularly preferable as the cooled material. Use of the cooling roller makes it possible to continuously perform semi-baking in an assembly-line operation in an industrial manner and makes it easier to control the temperature and maintain the apparatus. The temperature of the cooling roller can be set so as to generate a difference to the temperature for performing the semi-baking. The duration for the contact between the cooling roller and the film may be long enough to sufficiently perform the intended semi-baking, and considering the fact that it is performed at the same time as heating, is generally 30 seconds to 120 seconds, preferably 45 seconds to 90 seconds, and even more preferably 60 seconds to 80 seconds.

The surface material of the heating roller and cooling roller is generally stainless steel that is excellent in durability, particularly preferably SUS316. In the method for producing a crystalline polymer microporous membrane, it is also a preferable embodiment that the unheated surface of the film is brought into contact with a heating and cooling roller. Also, the heated surface of the film may be brought into contact with a roller having the temperature lower than the heating and cooling roller. For example, a roller maintaining ambient temperature may be brought into contact with and press the film from the heating surface of the film so as to make the film closely fit to the heating roller. Moreover, the heated surface of the film may be brought into contact with a guide roller before or after the contact with the heating roller.

Meanwhile, in the case where the heating in the asymmetric heating step is carried out intermittently, it is preferable to heat the second surface intermittently or cool the first surface of the film so as to restrain increase in the temperature of the first surface.

### <<Drawing Step>>

The semi-baked film is preferably drawn after the semi-baking. The drawing is preferably performed in the both the length direction and width direction. The film may be drawn in the length direction, followed by drawn in the width direction, or may be drawn in the biaxial direction at the same time.

In the case where the film is sequentially drawn in the length direction and width direction, it is preferred that the film be drawn in the length direction first, then be drawn in the width direction.

The extension rate of the film in the length direction is preferably 4 times to 100 times, more preferably 8 times to 90 times, and even more preferably 10 times to 80 times. The temperature for the drawing in the length direction is preferably 100° C. to 300° C., more preferably 200° C. to 290° C., and even more preferably 250° C. to 280° C.

The extension rate of the film in the width direction is preferably 10 times to 100 times, more preferably 12 times to 90 times, even more preferably 15 times to 70 times, and particularly preferably 20 times to 40 times. The temperature for the drawing in the width direction is preferably 100° C. to 300° C., more preferably 200° C. to 290° C., and even more preferably 250° C. to 280° C.

The extension rate of the film in terms of the area thereof is preferably 50 times to 300 times, more preferably 75 times 280 times, and even more preferably 100 times to 260 times. Before the drawing is performed on the film, the film may be pre-heated at the temperature equal to or lower than the temperature for the drawing.

Heat curing may be performed, if necessary, after the drawing. The temperature for the heat curing is generally equal to or higher than the temperature for the drawing, but is lower than the melting point of the baked crystalline polymer.

The filtration filter of the present invention detachably includes a cartridge formed of the crystalline polymer microporous membrane having an asymmetric pore structure produced as described above. The method for producing the cartridge will be described in the cartridge forming step in the method for producing the filtration filter of the present invention, which will be described below.

As described above, the method for producing a filtration filter of the present invention includes a crystalline polymer membrane forming step, a cartridge forming step, and a surface modification step, and may further include other steps, if necessary.

### <Crystalline Polymer Membrane Forming Step>

A crystalline polymer membrane forming step is a step of forming a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof.

The method for producing a crystalline polymer microporous membrane is as described above.

### <Cartridge Forming Step>

The cartridge forming step is forming the crystalline polymer microporous membrane into a cartridge.

A form of the cartridge formed of the crystalline polymer microporous membrane is suitably selected depending on the intended purpose without any restriction. Examples of the form of the filter include a pleated form in which a filtration membrane is corrugated, a spiral form in which a filtration membrane is continuously wound, a frame and plate form in which disc-shaped filtration membrane s are stacked on top of one another, and a tube form in which a filtration membrane is formed as a tube. Among them, a pleated form is particularly preferable in that the effective surface area used for filtration per cartridge can be increased.

The pleated form cartridge is formed as follows: the crystalline polymer microporous membrane is placed in between two pieces of polypropylene nonwoven fabrics, pleated so as to have a pleat width of 10.5 mm, and provided with 138 folds and formed into a cylindrical shape; the joint is fused using an impulse sealer so as to form a cylindrical object; both ends of the cylindrical object are cut by 2 mm each, and the cut surfaces are thermally fused with polypropylene end plates so as to prepare an element exchange type cartridge.

By using the crystalline polymer microporous membrane after it is formed into a cartridge, filtration is carried out with the unheated surface (i.e., the surface having the larger average pore diameter) facing the inlet side. In other words, the surface having the large pore size is used as the filtration surface of the filter. By carrying out filtration using the surface having the larger average pore diameter (i.e. the unheated surface) for the inlet side, it is possible to efficiently trap fine particles.

Cartridges are classified into element exchange type cartridges in which only filter elements are replaced when filtration membranes having been degraded need to be replaced, and capsule-type cartridges in which filter elements are provided integrally with filtration housings and both the filter elements and the housings are used in a disposable manner.

### <Surface Modification Step>

The surface modification step is subjecting at least part of the crystalline polymer microporous membrane formed into a cartridge (cartridge) to surface modification.

The term “at least part of a crystalline polymer microporous membrane” used here includes the exposed surfaces of the crystalline polymer microporous membrane formed into a cartridge and surroundings of the pores, and inner portions of the pores.

The surface modification method is suitably selected depending on the intended purpose without any restriction. Examples thereof include (1) impregnation of aqueous solution of hydrogen peroxide or water-soluble solvent, followed by laser irradiation, (2) chemical etching treatment, (3) covering the membrane with a crosslinking material, and (4) covering the membrane with a polymer material. Among them, (3) covering the membrane with a crosslinking material, and (4) covering the membrane with a polymer material are particularly preferable because a remarkable asymmetric pore structure can be formed, and filtration lifetime can be improved. Note that the above (1) and (2) have a problem that the inner portions of the crystalline polymer microporous membrane cannot be hydrophilized, decreasing membrane strength.

### <<(1) Impregnation of Aqueous Solution of Hydrogen Peroxide or Water-Soluble Solvent, Followed by Laser Irradiation>>

Examples of the water soluble organic solvent, which is used in the method of (1) impregnation of aqueous solution of hydrogen peroxide or water-soluble solvent in the crystalline polymer microporous membrane formed into a cartridge, followed by laser irradiation, include ethers such as tetrahydrofuran, 1,4-dioxane, ethylene glycol monoalkyl ether, ethylene glycol dialkyl ether, diethylene glycol monoalkyl ether, diethylene glycol dialkyl ether; ketones such as acetone, methyl ethyl ketone, cyclohexanone, diacetyl, acetylacetone; alcohols such as methanol, ethanol, propanol, hexyl alcohol, ethylene glycol, isopropyl alcohol, butanol, ethylene chlorohydrin, glycerine; aldehydes such as acetaldehyde, propionaldehyde; amines such as triethylamines, piperidine; and esters such as methyl acetate, ethyl acetate. Among them, ketones are preferable, acetone, methyl ethyl ketone are more preferable, and acetone is particularly preferable.

The concentration of the aqueous solution of hydrogen peroxide or a water soluble organic solvent in the process of impregnating the crystalline polymer microporous membrane formed into a cartridge with the aqueous solution slightly differs depending on the material of crystalline polymer microporous membrane and the size of fine pores. When acetone or methyl ethyl ketone is used, the concentration is preferably 85% by mass to 100% by mass. As for the concentration of the aqueous solution of hydrogen peroxide or a water soluble organic solvent inside the crystalline polymer microporous membrane by irradiating with ultraviolet laser, as expressed by a light absorbance at a wavelength of an ultraviolet laser, it is preferably 0.1 to 10. For instance, when acetone and KrF as a light source is used, the concentration is equivalent to 0.05% by mass to 5% by mass. The absorbance is preferably 0.1 to 6, and more preferably 0.5 to 5. When a crystalline polymer microporous membrane containing an aqueous solution of hydrogen peroxide or a water soluble organic solvent whose concentration is adjusted to fall within the above-mentioned range is irradiated with an ultraviolet laser, a satisfactory hydrophilic effect can be obtained with an exposure amount far lower than ever before.

Generally, when a water soluble organic solvent having a boiling point of 50° C. to 100° C. is used, the efficiency of hydrophilization treatment by ultraviolet laser irradiation is high, and the solvent is readily removed from the membrane that has been subjected to a hydrophilization treatment. However, when a water soluble organic solvent having a boiling point higher than 100° C. is used, it becomes difficult to remove the water soluble organic solvent from the membrane that has been subjected to the hydrophilization treatment.

When the hydrophilization treatment is carried out by irradiating with an ultraviolet laser a crystalline polymer microporous membrane formed into a cartridge which has been impregnated with a water soluble organic solvent, in order to obtain a uniform and high hydrophilization treatment effect, the water soluble solution of the aqueous organic solvent in the crystalline polymer microporous membrane has been impregnated with the water soluble organic solvent is impregnated with water, so as to adjust the concentration of the aqueous solution of the water soluble organic solvent in the crystalline polymer microporous membrane in terms of the absorbance at a wavelength of the ultraviolet laser used: it is 0.1 to 10, preferably 0.1 to 6, and particularly preferably 0.5 to 5. When the absorbance is lower than 0.1, it may become difficult to obtain a sufficient effect of the hydrophilization treatment, and when it is higher than 10, the aqueous solution largely absorbs the light energy, and it may becomes difficult to sufficiently provide inner portions of the pores with hydrophilicity.

As a method of impregnating the crystalline polymer microporous membrane with water to adjust the concentration of the aqueous solution of water soluble organic solvent in the microporous membrane, it is preferred that the microporous membrane be immersed in another aqueous solution which contains the same water soluble organic solvent at a substantially low concentration.

Note that the absorbance means an amount of light defined by the following expression.

Absorbance ≡log₁₀(I₀/I)=εcd

In the expression, ε represents an absorbance coefficient of a water soluble organic solvent, “c” represents a concentration (mole/dm³) of an aqueous solution of the water soluble organic solvent, “d” represents a length of transmitted optical path (cm), I₀ represents a light transmittance intensity of a solvent alone, and I represents a light transmittance intensity of the solution. In the present invention, a concentration of the aqueous solution with which the light absorbance becomes x means a concentration with which the light absorbance becomes x when measured using a measurement cell having 1 cm of “d”. However, in the case where such a high concentration that makes the measurement of light absorbance difficult due to excessively low quantity of transmitted light with the value of d being 1 cm, an absorbance obtained using a measurement cell having 0.2 cm of “d” is multiplied by 5, and the calculated value is determined as the absorbance.

The method of impregnating the crystalline polymer microporous membrane formed into a cartridge with the aqueous solution of hydrogen peroxide or water soluble organic solvent is suitably selected depending on the intended purpose without any restriction. An immersion method, an atomizing method, a coating method or the like may be suitably employed according to the shape and size of the crystalline polymer microporous membrane. Of these, the immersion method is generally used.

The impregnation temperature of the aqueous solution of hydrogen peroxide or water soluble organic solvent is preferably 10° C. to 40° C., from the perspective of diffusion rate of the aqueous solution into micropores of the crystalline polymer microporous membrane. When the impregnation temperature is lower than 10° C., a relatively long length of time is required to sufficiently diffuse the aqueous solution into the micropores. When it is higher than 40° C., it is unfavorable because the evaporation rate of the water soluble organic solvent is increased.

After the crystalline polymer microporous membrane is subjected to immersion treatment, the concentration of the aqueous solution of hydrogen peroxide or aqueous organic solvent is adjusted within the above-mentioned range, and then the microporous membrane is subjected to the following ultraviolet laser irradiation.

For the ultraviolet laser, those having a wavelength of 190 nm to 400 nm are preferable. Examples thereof include argon ion lasers, krypton ion lasers, N2 lasers, dye lasers, and excimer lasers. Excimer lasers are preferable. Of these, KrF excimer laser (wavelength: 248 nm), ArF excimer laser (wavelength: 193 nm), and XeCl excimer laser (308 nm) are particularly preferable because high output power is stably obtained for a long period of time.

Generally, the irradiation of excimer laser light is carried out at room temperature in the air. However, it is preferably performed in nitrogen atmosphere. The conditions of the irradiation of excimer laser light differs depending on the type of fluororesin used and the desired level of surface modification. Generally employed irradiation conditions are as follows:

Fluence 10 mJ/cm²/pulse or higher

Incident energy: 0.1 J/cm² or higher

Particularly suitably employed irradiation conditions of KrF excimer laser, ArF excimer laser, and XeCl excimer laser are as follows.

KrF fluence 50 mJ/cm²/pulse to 500 mJ/cm²/pulse

Incident energy: 0.25 J/cm² to 10.0 J/cm²

ArF fluence: 10 mJ/cm²/pulse to 500 mJ/cm²/pulse

Incident energy: 0.1 J/cm² to 10.0 J/cm²

XeCl fluence 50 mJ/cm²/pulse to 600 mJ/cm²/pulse

Incident energy: 3.0 J/cm² to 100 J/cm²

### <21 (2) Chemical Etching Treatment>>

For the (2) chemical etching treatment, oxidative decomposition is exemplified in which a fluororesin constituting the crystalline polymer microporous membrane formed into a cartridge is modified using an alkali metal, and the modified portions are removed.

The oxidative decomposition is carried out using, for example, an organic alkali metal solution. When the crystalline polymer microporous membrane formed into a cartridge is subjected to chemical etching treatment using a solution containing an organic alkali metal, the surface of the crystalline polymer microporous membrane formed into a cartridge is modified so that hydrophilicity is imparted to the crystalline polymer microporous membrane and a brownish layer is formed thereon. This brownish layer is composed of sodium fluoride, a decomposed product of fluororesin having a carbon-carbon double bond, and polymers from these substances, naphthalene and anthracene. These substances are preferably removed therefrom because they may be left out, dissolved, and/or eluted, and thereby mixed in a filtration liquid. These substances can be removed by oxidative decomposition with use of hydrogen peroxide, hypochlorous acid soda, ozone, etc.

The chemical etching treatment can be carried out using a solution containing an organic alkali metal. Specifically, it can be carried out by immersing the crystalline polymer microporous membrane formed into a cartridge in a solution containing an organic alkali metal. In this case, since the crystalline polymer microporous membrane formed into a cartridge is subjected to a chemical etching treatment from its surface, it is also possible to provide only portions in proximity to the both surfaces of the membrane with the chemical etching treatment. However, in order to increase the water retention of the crystalline polymer microporous membrane, it is preferable to provide not only the portions in proximity to the both surfaces of the crystalline polymer microporous membrane but also the inside of the membrane with the chemical etching treatment. Even when the chemical etching treatment is provided to the inside of the crystalline polymer microporous membrane formed into a cartridge, reduction in function as a separation membrane is suppressed.

Examples of the organic alkali metal solution for use in the chemical etching treatment include organic solvent solutions of methyl lithium, a metallic sodium-naphthalene complex, tetrahydrofuran of a metallic sodium-anthracene complex, etc.; and solutions of metallic sodium-liquid ammonia. Among them, typically, a solution of a complex between metallic sodium and an aromatic anion-radical as naphthalene is widely used, however, in order to provide the chemical etching treatment to the inside of the crystalline polymer microporous membrane, it is preferable to use benzophenon, anthracene or biphenyl as the aromatic anion radical.

<<(3) Covering Membrane with Crosslinking Material>>

The crosslinking material is suitably selected depending on the intended purpose without any restriction. Examples thereof include a hydrophilic polymer, surfactant, polyhydric alcohol, polyamine, and fluorine alcohol. These crosslinking materials are preferably crosslinked using a crosslinking agent.

### —Hydrophilic Polymer—

The hydrophilic polymer is suitably selected depending on the intended purpose without any restriction, provided that the polymer contains hydroxyl groups. Examples thereof include: polyvinyl alcohol (PVA); polysaccharide such as agarose, dextran, chitosan, and cellulose, and derivatives thereof; and gelatin. These may be used independently, or in combination. Among them, polyvinyl alcohol (PVA) is preferable.

A saponification value of polyvinyl alcohol is suitably selected depending on the intended purpose without any restriction, but is preferably 50 to 100, more preferably 60 to 100. When the saponification value of polyvinyl alcohol is less than 50, hydrophilic properties thereof may be insufficient.

A molecular weight of polyvinyl alcohol is suitably selected depending on the intended purpose without any restriction, but is preferably 200 to 150,000, more preferably 500 to 100,000. When the molecular weight of polyvinyl alcohol is less than 200, polyvinyl alcohol cannot be fixed on a microporous membrane, not being able to provide hydrophilicity to the microporous membrane. When the molecular weight of polyvinyl alcohol is more than 150,000, polyvinyl alcohol does not penetrate into a microporous membrane, not being able to provide hydrophilicity to the inner portion of the microporous membrane.

The commercially available polyvinyl alcohol is suitably selected depending on the intended purpose without any restriction. Examples of commercially available polyvinyl alcohol include RS2117 (Mw: 74,800), PVA103 (Mw: 13,200, saponification value: 98 to 99), PVA-HC (saponification value: 99.85 or more), PVA-205C (Mw: 22,000, high purity, saponification value: 87 to 89), M-205 (Mw: 22,000, saponification value: 87 to 89), and M-115 (Mw: 66,000, saponification value: 97 to 98), all manufactured by Kuraray Co., Ltd.

A method for covering the crystalline polymer microporous membrane with the hydrophilic polymer is suitably selected depending on the intended purpose without any restriction. For example, there is a method in which a formulated liquid including the hydrophilic polymer is applied to the crystalline polymer microporous membrane formed into a cartridge by immersing or coating, so as to cover the crystalline polymer microporous membrane with the hydrophilic polymer.

A concentration of polyvinyl alcohol in the formulated liquid including the hydrophilic polymer is suitably selected depending on the intended purpose without any restriction, but is preferably 0.001% by mass to 20% by mass, more preferably 0.002% by mass to 15% by mass, and even more preferably 0.003% by mass to 10% by mass.

When the concentration of polyvinyl alcohol is less than 0.001% by mass, the entire crystalline polymer microporous filter may not have hydrophilicity. When the concentration thereof is more than 20% by mass, polyvinyl alcohol may fill some of pours of the crystalline polymer microporous filter, which decreases a filtration flow rate thereof.

A solvent of the hydrophilic polymer used for the formulated liquid including the hydrophilic polymer is suitably selected depending on the intended purpose without any restriction. Examples thereof include: water; alcohols such as methanol, ethanol, isopropanol, ethylene glycol; ketones such as acetone, and methyl ethyl ketone; ethers such as tetrahydrofuran, dioxane, propylene glycol monomethyl ether acetate; dimethyl formamide; and dimethyl sulfoxide.

The crystalline polymer microporous membrane onto which the formulated liquid including the hydrophilic polymer has been applied by immersion or application is preferably subjected to annealing.

The temperature for the annealing is preferably 50° C. to 200° C., more preferably 60° C. to 180° C., and particularly preferably 70° C. to 160° C.

When the temperature is lower than 50° C., crystallization of polyvinyl alcohol is not accelerated, or crosslinking reaction is not accelerated by annealing, causing poor water resistance of the membrane. When the temperature is higher than 200° C., a hydrophilic polymer may be decomposed.

The hydrophilic polymer is preferably crosslinked using a crosslinking agent. Such crosslinkages improve the durability of the crystalline polymer microporous membrane.

The crosslinking agent is suitably selected depending on the intended purpose without any restriction. Examples thereof include an epoxy compound, an isocyanate compound, an aldehyde compound, a UV-crosslinkable compound, a leaving group-containing compound, a carboxylic acid compound, and a urea compound. Among them, the epoxy compound is preferable. When the epoxy compound is used as the crosslinking agent, the formed crosslinkages including ether bondings provide the crystalline polymer microporous membrane with acid resistance and alkali resistance.

The epoxy compound is suitably selected depending on the intended purpose without any restriction. Examples thereof include: monoglycidyl ethers and polyglycidyl ethers, such as ethylene glycol diglycidyl ether, and polyethylene glycol diglycidyl ether; epoxy compounds of glycerol derivatives, pentaerythritol derivatives, sorbitol derivatives, and isocyanurate derivatives.

Examples of the commercially available epoxy compound include: ethylene glycol diglycidyl ether and triglycidyl ether isocyanate (manufactured by TOKYO CHEMICAL INDUSTRY CO., LTD.); EPIOL E400 (manufactured by NOF Corporation); and DENACOL EX313, DENACOL EX411, and DENACOL EX614B (manufactured by Nagase ChemteX Corporation).

The isocyanate compound is suitably selected depending on the intended purpose without any restriction. Examples thereof include: aromatic isocyanate such as tolylene diisocyanate, naphthalene diisocyanate, tolidine diisocyanate, xylene diisocyanate, diphenylmethane diisocyanate, and triphenylmethane triisocyanate; aliphatic isocyanate such as hexamethylene diisocyanate, hexamethylene triisocyanate, and lysine ester triisocyanate; and alicyclic isocyanate such as isophorone diisocyanate.

The UV crosslinkable compound is suitably selected depending on the intended purpose without any restriction. Examples thereof include a vinyl group-containing compound, an acrylate group-containing compound, and a methacrylate group-containing compound. Specific examples thereof include paravinyl phenol, methyl acrylate, acrylic acid, methyl methacrylate, and methacrylic acid.

The leaving group-containing compound is suitably selected depending on the intended purpose without any restriction. Examples thereof include tetraethyleneglycol ditosylate, chlorotriazine, and derivatives thereof.

The crosslinked state of the crystalline polymer microporous membrane can be confirmed by extracting in a solvent such as methanol, water, and DMF, and measuring and analyzing the extracted substance by NMR, IR, or the like.

It is also confirmed by measuring and analyzing bonds generated during a crosslinking reaction by IR, NMR, or the like.

### —Surfactant—

The surfactant is suitably selected depending on the intended purpose without any restriction. A fluorosurfactant is particularly preferable.

The fluorosurfactant is suitably selected depending on the intended purpose without any restriction. Examples thereof include an anionic surfactant, a cationic surfactant, a nonionic surfactant, and betaine. These may be used independently, or in combination. Among them, the nonionic fluorosurfactant is preferable, because such surfactant can provide the crystalline polymer microporous membrane with excellent hydrophilicity, acid resistance and alkali resistance.

It is preferred that the fluorosurfactant contain at least one functional group selected from the group consisting of a hydroxyl group, an amino group, and a derivative group thereof. The embodiment that the fluorosurfactant contains the aforementioned functional groups at the terminals thereof is more preferable. By substituting groups contained in a molecule of the fluorosurfactant with the functional group (may be referred to as a hydrophilic group hereinafter), the fluorosurfactant is provided with hydrophilicity.

The hydrophilic group substitution rate in the molecule of the fluorosurfactant is suitably selected depending on the intended purpose without any restriction, but it is preferably 15% to 90%, more preferably 17.5% to 80%, and even more preferably 20% to 70%. When the substitution rate is less than 15%, the hydrophilization of the crystalline polymer microporous membrane may be insufficient. When the substitution rate is more than 90%, it may be difficult for the crystalline polymer microporous membrane to adsorb such fluorosurfactant thereon, and thus the desired coverage thereof may not be attained.

Moreover, it is more preferable that the fluorosurfactant includes no ester bonding in the molecule thereof, and has acid resistance, and alkali resistance.

Examples of such fluorosurfactant include the compound expressed by the following general formula 1, and the compound expressed by the following general formula 2. Among them, the compound expressed by the following general formula 1 is particularly preferable.

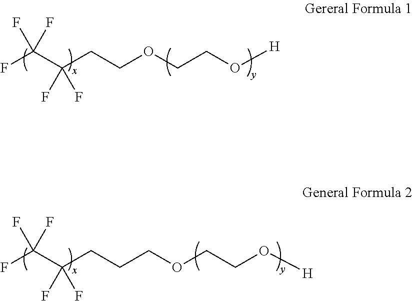

In the general formulae 1 and 2 above, “x” is suitably selected depending on the rate of the hydrophilic group substitution and the like, without any restriction, but it is preferably 2 to 10, more preferably 3 to 8.

In the general formulae 1 and 2 above, “y” is suitably selected depending on the rate of the hydrophilic group substitution and the like, without any restriction, but it is preferably 1 to 100, more preferably 1 to 10.

The method for obtaining the fluorosurfactant is suitably selected depending on the purpose without any restriction. For example, the fluorosurfactant is obtained by synthesizing the same, or obtained by selected from the commercially available products.

The compounds expressed by the general formulae 1 and 2 can be synthesized by an addition reaction of a fluoroalcohol and epoxide For example, the method described in S. M. Heilmann et al., J. Fluorine Chem, 59, 1992, 387-396, or the method described in “Fluorinated surfactants and repellents” Erik Kissa, MARCEL DEKKER, INC., pp. 64-69 can be used.

The fluoroalcohol for used in the synthesis may be selected from the commercial products. Examples of such commercial product include A-1420 (F(CF₂)₄CH₂CH₂OH), A-1620 (F(CF₂)₆CH₂CH₂OH), and A-1630 (F(CF₂)₆(CH₂)₃OH), all manufactured by Daikin Chemical Sales Ltd.

The commercial product of the fluorosurfactant is suitably selected depending on the intended purpose without any restriction. Examples thereof include Zonyl FSN100 (nonionic fluorosurfactant, manufactured by Sigma-Aldrich Corporation), and SURFLON S-145 (nonionic fluorosurfactant, manufactured by AGC Seimi Chemical Co., Ltd.).

The fluorosurfactant is preferably crosslinked with assistance of a first crosslinking agent. Such crosslinkages contribute to maintain hydrophilicity of the membrane for a long period of time, expand the life time of the crystalline polymer microporous membrane as a filter, and improve the durability of the crystalline polymer microporous membrane.

Moreover, the first crosslinking agent is preferably crosslinked using a second crosslinking agent. By crosslinking the first crosslinking agent with assistance of the second crosslinking agent, water resistance, chemical resistance, and the like of the crystalline polymer microporous membrane are improved.

### —First Crosslinking Agent—

The crosslinking agent is suitably selected depending on the intended purpose without any restriction. Examples thereof include an epoxy compound, an isocyanate compound, an aldehyde compound, a UV-crosslinkable compound, a leaving group-containing compound, a carboxylic acid compound, and a urea compound. These may be used independently, or in combination.

Among them, the epoxy compound is preferable, and the polyfunctional epoxy compound having two or more functional groups per molecule is more preferable. When the epoxy compound is used as the crosslinking agent, the formed crosslinkages including ether bondings provide the crystalline polymer microporous membrane with acid resistance and alkali resistance.

### —Epoxy Compound—

The epoxy compound is suitably selected depending on the intended purpose without any restriction. Examples thereof include: monoglycidyl ethers and polyglycidyl ethers, such as ethylene glycol diglycidyl ether, and polyethylene glycol diglycidyl ether; epoxy compounds of glycerol derivatives, pentaerythritol derivatives, sorbitol derivatives, and isocyanurate derivatives.

Examples of the commercially available epoxy compound include: ethylene glycol diglycidyl ether and triglycidyl ether isocyanate (manufactured by TOKYO CHEMICAL INDUSTRY CO., LTD.); EPIOL E400 (manufactured by NOF Corporation); and DENACOL EX313, DENACOL EX411, and DENACOL EX614B (manufactured by Nagase ChemteX Corporation).

### —Isocyanate Compound—

The isocyanate compound is suitably selected depending on the intended purpose without any restriction. Examples thereof include: aromatic isocyanate such as tolylene diisocyanate, naphthalene diisocyanate, tolidine diisocyanate, xylene diisocyanate, diphenylmethane diisocyanate, and triphenylmethane triisocyanate; aliphatic isocyanate such as hexamethylene diisocyanate, hexamethylene triisocyanate, and lysine ester triisocyanate; and alicyclic isocyanate such as isophorone diisocyanate.

### —Aldehyde Compound—

The aldehyde compound is suitably selected depending on the intended purpose without any restriction. Examples thereof include formaldehyde, and glutaraldehyde.

### —UV Crosslinkable Compound—

The UV crosslinkable compound is suitably selected depending on the intended purpose without any restriction. Examples thereof include a vinyl group-containing compound, an acrylate group-containing compound, and a methacrylate group-containing compound. Specific examples thereof include paravinyl phenol, methyl acrylate, acrylic acid, methyl methacrylate, and methacrylic acid.

### —Leaving Group-Containing Compound—

The leaving group-containing compound is suitably selected depending on the intended purpose without any restriction. Examples thereof include tetraethyleneglycol ditosylate, and chlorotriazine.

### —Second Crosslinking Agent—

The second crosslinking agent is suitably selected depending on the intended purpose without any restriction. Examples thereof include polyhydric alcohol, polyamine, and derivatives thereof.

It is preferred that the polyhydric alcohol contain at least two hydroxyl groups, that the polyamine contain at least two amino groups, and that the derivative of the polyhydric alcohol or polyamine contain at least one hydroxyl group and at least one amino group.

These second crosslinking agents are suitably used especially when the first crosslinking agent is at least one selected from the group consisting of the epoxy compound, isocyanate, aldehyde, and a leaving group-containing compound.

Specific examples of the second crosslinking agent include: polyhydric alcohols such as glycerin, diglycerin, polyglycerin, propylene glycol, 1,3-butylene glycol, hexylene glycol, isoprene glycol, dipropylene glycol, ethylene glycol, ethylene glycol monomethyl ether, diethylene glycol monomethyl ether, polyethylene glycol, erythritol, pentaerythritol, dipentaerythritol, sorbitol, monosaccharides, polysaccharides, and derivatives thereof; and polyamines such as ethylene diamine, diethylene triamine, triethylene tetraamine, tetraethylene pentaamine, pentaethylene hexamine, straight or branched chain polyethylene imine, Jeffamine, and derivatives thereof. These may be used independently or in combination.

Among them, pentaethylene hexamine, and ethylene glycol are preferable.

Moreover, a compound having two or more functional groups reactive with ultraviolet rays can also be used as the second crosslinking agent. Examples thereof include a divinyl compound, a diacryl compound, and a dimethacryl compound.

These second crosslinking agents are suitably used especially when the first crosslinking agent is the UV crosslinkable compound.

Specific examples of such second crosslinking agent include divinyl benzene, trimethylol propane triacrylate, polyethylene glycol diacrylate, and polyethylene glycol dimethactylate.

It is preferred that a crosslinking accelerator be added to the first crosslinking agent, as crosslinking reactions are efficiently performed.

The crosslinking accelerator is suitably selected depending on the intended purpose without any restriction. Examples thereof include: alkaline compounds such as potassium hydroxide; acid compounds such as hydrochloric acid.

The fluorosurfactant is applied (by immersion or coating) to a crystalline polymer microporous membrane formed into a cartridge, followed by being subjected to annealing, to thereby cover an exposed surface of the crystalline polymer microporous membrane with the fluorosurfactant.

When the fluorosurfactant is applied, in the case where the first and second crosslinking agents are further applied (by immersion or coating), an exposed surface of the crystalline polymer microporous membrane formed into a cartridge is covered with the fluorosurfactant, and then the fluorosurfactant is crosslinked with assistance of the first crosslinking agent, and moreover the first crosslinking agent is crosslinked with assistance of the second crosslinking agent, by annealing.

When the fluorosurfactant is applied, and when the first and second crosslinking agents and a crosslinking accelerator are optionally applied, a solvent used for such application is suitably selected depending on the intended purpose without any restriction. Examples thereof include: water; alcohols such as methanol, ethanol, isopropanol, ethylene glycol; ketones such as acetone, and methyl ethyl ketone; ethers such as tetrahydrofuran, dioxane, propylene glycol monomethyl ether acetate; dimethyl formamide; and dimethyl sulfoxide.

The amount of the fluorosurfactant for use is suitably selected depending on the intended purpose without any restriction, provided that the desirable coverage rate is satisfied.

An amount of the first crosslinking agent for use is suitably selected depending on the amount of the fluorosurfactant or the like. The amount of the first crosslinking agent is preferably 1 part by mass to 10,000 parts by mass, more preferably 2.5 parts by mass to 7,500 parts by mass, and even more preferably 5 parts by mass to 5,000 parts by mass relative to 100 parts by mass of the fluorosurfactant.

When the amount of the first crosslinking agent is less than 1 part by mass relative to 100 parts by mass of the fluorosurfactant, a crystalline polymer microporous membrane cannot attain high hydrophilicity and a long life time as a filtration filter. When the amount of the first crosslinking agent is more than 10,000 parts by mass, an excessive amount of unreacted functional groups of the first crosslinking agent remains, which may adversely affect hydrophilicity of the crystalline polymer microporous membrane.

The first crosslinking agent may be applied after or at the same time as when the fluorosurfactant is applied to the crystalline polymer microporous membrane (by immersion or coating).

An amount of the second crosslinking agent for use is suitably selected depending on the amount of the first crosslinking agent or the like. The amount of the second crosslinking agent is preferably 0.1 parts by mass to 1,000 parts by mass, more preferably 0.25 parts by mass to 750 parts by mass, and even more preferably 0.5 parts by mass to 500 parts by mass relative to 100 parts by mass of the first crosslinking agent.

When the amount of the second crosslinking agent is less than 0.1 parts by mass relative to 100 parts by mass of the first crosslinking agent, water resistance of the resulting crystalline polymer microporous membrane may not be improved. When the amount of the second crosslinking agent is more than 1,000 parts by mass, the reactivity to the fluorosurfactant may reduce.

The second crosslinking agent may be applied after or at the same time as when the fluorosurfactant and the first crosslinking agent are applied to the crystalline polymer microporous membrane (by immersion or coating).

An amount of the crosslinking accelerator for use is suitably selected depending on the intended purpose without any restriction.

The temperature for the annealing is preferably 100° C. to 180° C., and more preferably 120° C. to 150° C.

The duration for the heating is preferably 1 minute to 60 minutes, more preferably 1 minute to 45 minutes, and even more preferably 1 minute to 30 minutes.

When the temperature for the annealing is lower than 100° C. or the duration is shorter than 1 minute, hydrophilization or a crosslinking reaction may not be sufficiently progressed, and as a result, water resistance, acid resistance, alkali resistance or the like of the resulting crystalline polymer microporous membrane may be impaired. When the temperature for the annealing is higher than 180° C. or the duration is longer than 60 minutes, the fluorosurfactant, the first crosslinking agent, the second crosslinking agent, and the like may be decomposed.

At the time when the fluorosurfactant, optionally the first crosslinking agent and the second crosslinking agent are applied, other additives such as an antioxidant and the like can be added, provided that they do not adversely affect the obtainable effect of the present invention.

Examples of the commercial products of the antioxidant include dibutylhydroxytoluene (BHT), IRGANOX 1010, IRGANOX 1035FF, and IRGANOX 565.

### —Polyhydric Alcohol—

The polyhydric alcohol is suitably selected depending on the intended purpose without any restriction, provided that it is a compound having two or more hydroxyl groups per molecule. Examples thereof include glycerin compounds such as glycerin, diglycerin, and polyglycerin; glycol compounds such as ethylene glycol, propylene glycol, 1,3-butylene glycol, hexylene glycol, isoprene glycol, dipropylene glycol, and polyethylene glycol; ether compounds such as ethylene glycol monomethyl ether, and diethylene glycol monomethyl ether; erythritol compounds such as erythritol, pentaerythritol, and dipentaerythritol; sorbitol; monosaccharides such as glucose, and galactose; polysaccharides such as sucrose, lactose, maltose, cellulose, dextrin, and pullulan; and derivatives thereof. These may be used independently, or in combination.

Among them, ethylene glycol, glycerin, diglycerin, polyglycerin, erythritol, pentaerythritol, dipentaerythritol, sorbitol, glucose, galactose, sucrose, lactose, maltose, cellulose, dextrin, and pullulan are preferable, because water resistance is improved owing to many crosslinking points.

### —Polyamine—

The polyamine is an amine compound having two or more amino groups per molecule.

Examples thereof include ethylene diamine, diethylene triamine, triethylenetetramine, tetraethylenepentamine, pentaethylenehexamine, straight or branched polyethyleneimine, Jeffamine, and derivatives thereof. These may be used independently, or in combination.

### —Fluorine Alcohol—

The fluorine alcohol is a fluorine compound having a hydroxyl group in a molecular structure thereof.

Examples thereof include A-1420, A-1620, A-7412, A-7612 (manufactured by DAIKIN INDUSTRIES, LTD.), 2,2,3,3-tetrafluoro-1,4-butandiol or derivatives thereof. These may be used independently, or in combination. Among them, the fluorine alcohol having two or more hydroxyl groups per molecule is particularly preferable, in terms of improvement of durability.

<<(4) Covering Membrane with Polymer Material>>

The polymer material is suitably selected depending on the intended purpose without any restriction. Examples thereof include a cationic polymer, a vinyl acetate polymer, an ethylene oxide polymer, and a vinyl compound.

### —Cationic Polymer—

The cationic polymer is obtained by cationically polymerizing a cationically polymerizable composition containing at least a cationically polymerizable monomer.

The cationically polymerizable composition contains at least a cationically polymerizable monomer, and further contains a cationic polymerization initiator, a solvent, and still further contains other components as necessary.

The cationically polymerizable monomer means a polymerizable compound which can initiate polymerization using a cationic species.

Examples of the cationically polymerizable monomer include an epoxy compound, an oxetane compound, and a vinyl compound. These may be used independently, or in combination.

### —Epoxy Compound—

As the epoxy compound, any of an aliphatic epoxy compound and an alicyclic epoxy compound can be used.

The aliphatic epoxy compound is suitably selected depending on the intended purpose without any restriction. Examples thereof include aliphatic polyhydric alcohol and polyglycidyl ether of alkylene oxide adduct thereof. Specific examples thereof include ethylene glycol diglycidyl ether, diethylene glycol diglycidyl ether, propylene glycol diglycidyl ether, tripropylene glycol diglycidyl ether, neopentyl glycol diglycidyl ether, 1,4-butandiol diglycidyl ether, 1,6-hexanediol diglycidyl ether, trimethylolpropane triglycidyl ether, trimethylolpropane diglycidyl ether, polyethylene glycol diglycidyl ether, pentaerythritol tetraglycidyl ether, bisphenol A diglycidyl ether, bisphenol AD diglycidyl ether, bisphenol S diglycidyl ether, hydrogenated bisphenol A diglycidyl ether, bisphenol F diglycidyl ether, bisphenol G diglycidyl ether, tetramethyl bisphenol A diglycidyl ether, bisphenol hexafluoroacetone diglycidyl ether, bisphenol C diglycidyl ether, dibromomethylphenyl glycidyl ether, dibromophenyl glycidyl ether, dibromomethylphenyl glycidyl ether, bromophenyl glycidyl ether, dibromometacrecidyl glycidyl ether, dibromoneopentyl glycol diglycidyl ether. These may be used independently, or in combination.

Examples of the commercially available aliphatic epoxy compound include EPOLIGHT 100MF (trimethylolpropane triglycidyl ether) (manufactured by KYOEISHA CHEMICAL CO., LTD.); EX-411, EX-313, EX-614B (manufactured by Nagase ChemiteX Corporation); and EPIOL E400 (manufactured by NOF CORPORATION).

The alicyclic epoxy compound is suitably selected depending on the intended purpose without any restriction. Examples thereof include vinylcyclohexene monoxide, 1,2-epoxy-4-vinylcyclohexane, 1,2:8,9 Diepoxylimonen, and 3,4-epoxycyclohexenylmethyl-3′,4′-epoxycyclohexanecarboxylate. These may be used independently, or in combination.

Examples of the commercially available alicyclic epoxy compound include CEL2000, CEL3000, and CEL2021P (manufactured by Daicel Chemical Industries, Ltd.).

### —Oxetane Compound—

The oxetane compound is a compound having a four-membered cyclic ether, i.e., oxetane ring, in a molecule thereof.

The oxetane compound is suitably selected depending on the intended purpose without any restriction. Examples thereof include 3-ethyl-3-hydroxymethyl-oxetane, 1,4-bis[(3-ethyl-3-oxetanylmethoxy)methyl]benzene, 3-ethyl-3-(phenoxymethyl)oxetane, bis(3-ethyl-3-oxetanylmethyl)ether, 3-ethyl-3-(2-ethylhexyloxymethyl)oxetane), 3-ethyl-3-[{3-(triethoxysilyl)propoxy}methyl]oxetane, oxetanyl silsesquioxane, phenol novolak oxetane. These may be used independently, or in combination.

The oxetanyl silsesquioxane is a silane compound having an oxetanyl group. For example, it is a polysiloxane compound which has a network structure including a plurality of oxetanyl groups, and is obtained by hydrolysis condensation of 3-ethyl-3-[{3-(triethoxysilyl)propoxy}methyl]oxetane.

Examples of the commercially available oxetane compound include OXT-101 (3-ethyl-3-hydroxymethyl oxetane), OXT-211 (3-ethyl-3-(phenoxymethyl)oxetane), OXT-221 (di[1-ethyl(3-oxetanyl)]methyl ether), OXT-212 (3-ethyl-3-(2-ethylhexyloxymethyl)oxetane), which are products of TOAGOSEI CO., LTD.

### —Vinyl Compound—

The vinyl compound is suitably selected depending on the intended purpose without any restriction, provided that it is cationically polymerizable. Examples thereof include a styrene compound, a vinyl ether compound and an N-vinyl compound. Among them, a vinyl ether compound is particularly preferable in terms of easiness of performing cationic polymerization.

The styrene compound means styrene, or a compound having a structure in which a hydrogen atom of an aromatic ring of styrene is substituted with an alkyl group, an alkyloxy group, or a halogen group.

Examples the styrene compound include p-methyl styrene, m-methyl styrene, p-methoxystyrene, m-methoxystyrene, α-methyl-p-methoxystyrene, and α-methyl-m-methoxystyrene. These may be used independently, or in combination.

The vinyl ether compound means a compound having the structure expressed by the following formula.

H₂C═CH—R¹—O—R²

In the formula above, R¹ represents a single bond or an alkylene group, and R² represents an alkyl group or a cycloalkyl group.

Examples of the vinyl ether compound include methyl vinyl ether, ethyl vinyl ether, propyl vinyl ether, isopropyl vinyl ether, butyl vinyl ether, isobutyl vinyl ether, hexyl vinyl ether, cyclohexyl vinyl ether, methylpropenyl ether, ethylpropenyl ether, butylpropenyl ether, methyl butenyl ether, and ethyl butenyl ether. These may be used independently, or in combination.

The N-vinyl compound means a compound having the structure expressed by the following formula.

H₂C═CH—NR³— or H₂C═CH—N═

In the formula above, R³ represents a hydrogen atom or an alkyl group.

Examples of the N-vinyl compound include N-vinylacetamide, N-vinylformamide, N-vinylpiperidone, and N-vinylcarbazole. These may be used independently, or in combination.

The amount of the cationically polymerizable monomer in the hydrophilic composition is preferably 0.1% by mass to 50% by mass, more preferably 0.2% by mass to 25% by mass. When the amount is less than 0.1% by mass, sufficient hydrophilicity may not be given to the crystalline polymer microporous membrane formed into a cartridge. When the amount is more than 50% by mass, the hydrophilic composition has excessively high viscosity, and cannot permeate into the crystalline polymer microporous membrane, causing insufficient hydrophilization of the inner portion of the membrane.

With part of the cationically polymerizable monomer, the functional compound containing at least one of an ion-exchange group and a chelate group may be subjected to addition reaction.

### —Functional Compound—

The functional compound is suitably selected depending on the intended purpose without any restriction, provided that it contains at least one of an ion-exchange group and a chelate group. The functional compound further contains a reactive group which reacts with the cationically polymerizable monomer, and further contains other components if necessary.

### —Ion-Exchange Group—

The ion-exchange group is a functional group which captures a metal ion and the like by ionic bonding.

The ion-exchange group is suitably selected depending on the intended purpose without any restriction, provided that it is a functional group which bonds to a metal ion with an ionic bond. Examples thereof include cation-exchange groups such as a sulfonic acid group, a phosphoric acid group, a carboxyl group, and anion-exchange groups such as a primary amino group, a secondary amino group, a tertiary amino group, a quaternary amino group, and a quaternary ammonium base.

### —Chelate Group—

The chelate group is a functional group which captures a metal ion and the like by chelate (coordinate) bonding.

The chelate group is suitably selected depending on the intended purpose without any restriction, provided that it is a functional group which bonds to a metal ion with a chelate (coordinate) bond. Examples thereof include multidentate ligands such as a nitrilotriacetic acid derivative (NTA) group, an iminodiacetic acid group, an iminodiethanol group, an amino polycarboxylic acid, aminopolyphosphonic acid, a porphyrin skeleton, a phthalocyanine skeleton, cyclic ether, cyclic amine, phenol, a lysine derivative, a phenanthroline group, a terpyridine group, a bipyridine group, a triethylenetetramine group, a diethylenetriamine group, a tris(carboxymethyl)ethylenediamine group, a diethylenetriaminepentaacetic acid group, a polypyrazolyl boric acid group, a 1,4,7-triazacyclononane group, a dimethyl glyoxime group, and a diphenyl glyoxime group.

—Reactive Group with Cationically Polymerizable Monomer—

The reactive group which reacts with the cationically polymerizable monomer is suitably selected depending on the intended purpose without any restriction. Examples thereof include an amino group, a hydroxyl group, an isocyanate group, a thiol group, a carboxyl group, and derivative groups thereof. An amino group, a hydroxyl group and derivatives thereof are preferably used.

Examples of the compound having the reactive group include hydroxyethyl iminodiacetic acid, nitrilotriacetic acid, hydroxyethylenediamine triacetic acid, bishydroxyethyl glycine, amino carboxypenty liminodiacetic acid (manufactured by DOJINDO LABORATORIES), and taurine, hydroxypropylsulfonic acid, phosphorylethanolamine, and choline (manufactured by Tokyo Chemical Industry Co., Ltd.).

—Functional Compound immobilized in Membrane—

The cationically polymerizable monomer is applied so as to cover a wall of the pore of the crystalline polymer microporous membrane, and is polymerized to fix the cationically polymerizable monomer to the wall. Therefore, the functional compound is immobilized in the crystalline polymer microporous membrane in the state of the noncovalent bonding, by allowing the functional compound to cause an addition reaction with a remaining epoxy group in the cationic polymer obtained from the cationically polymerizable monomer.

The state where the functional compound is immobilized in the crystalline polymer microporous membrane can be confirmed by the back-titration technique described in JP-A No. 2005-131482 or the like.

### —Cationic Polymerization Initiator—

As the cationic polymerization initiator, a cationic thermopolymerization initiator or a cationic photopolymerization initiator can be suitably used.

### —Cationic Thermopolymerization Initiator—

The cationic thermopolymerization initiator is suitably selected depending on the purpose without any restriction. Examples thereof include benzylsulfonium salt, a thiophenium salt, a thiolanium salt, benzylammonium, a pyridinium salt, a hydrazinium salt, carboxylic acid ester, sulfonic acid ester, and amineimide. These may be used independently, or in combination.

As the cationic thermopolymerization initiator, commercially available products can be used. Examples thereof include ADEKAOPTON CP77, ADEKAOPTON CP77 (manufactured by Asahi Denka Kogyo Co., Ltd.); CI-2639, CI-2624 (manufactured by Nihon Soda Co., Ltd.); and SANAID SI-80L, SANAID SI-100, SANAID SI-60L (manufactured by Sanshin Chemical Industry Co., Ltd.).

### —Cationic Photopolymerization Initiator—

The cationic photopolymerization initiator generates a cationic species or Lewis acid by irradiation of active energy ray such as visible light ray, an ultraviolet ray, an X-ray, and an electron beam, to thereby initiate polymerization.

As the cationic photopolymerization initiator, a sulfonium salt compound and an iodonium salt compound are exemplified.

Examples of the sulfonium salt compound include triphenylsulfonium hexafluorophosphate, triphenylsulfonium hexafluoroantimonate, triphenylsulfonium tetrakis (pentafluorophenyl) borate, 4,4′-bis[diphenylsulfonium]diphenylsulfide bis-hexafluorophosphate, 4,4′-bis[di(β-hydroxyethoxy)phenylsulfonium]diphenylsulfide bis-hexafluoroantimonate, 4,4′-bis[di([3-hydroxyethoxy)(phenylsulfonium)diphenyl sulfide-bishexafluorophosphate, 7-[di(p-tolyl) sulfonium]-2-isopropylthioxanthone hexafluoroantimonate, 7-[di(p-tolyl)sulfonio-2-isopropylthioxanthone tetrakis (pentafluorophenyl)borate, 4-phenylcarbonyl-4′-diphenylsulfonium-diphenylsulfide hexafluorophosphate, 4-(p-tert-butylphenylcarbonyl)-4′-diphenylsulfonium diphenylsulfide hexafluoroantimonate, 4-(p-tert-butylphenylcarbonyl-4′-di(p-tolyl)sulfonio-diphenylsulfide tetrakis (pentafluorophenyl) borate. These may be used independently, or in combination.

Examples of the iodonium salt compound include diphenyliodonium tetrakis (pentafluorophenyl)borate, diphenyliodonium hexafluorophosphate, diphenyliodonium hexafluoroantimonate and di(4-nonylphenyl)iodonium hexafluorophosphate. These may be used independently, or in combination.

Examples of the commercially available cationic photopolymerization initiator include triarylsulfonium salt compounds such as CYRACURE UVI-6992, UVI-6976 (manufactured by Dow Chemical Japan Limited), Adekaoptomer SP-150, SP-152, SP-170, SP-172 (manufactured by Asahi Denka Kogyo Co., Ltd.); diaryliodonium salt compounds such as RHODORSIL PHOTOINITIATOR 2074 (manufactured by Rhodia Japan Ltd.), IRGACURE 250 (manufactured by CIBA Specialty Chemicals Ltd.), CI-5102 (manufactured by Nihon Soda Co., Ltd.) and WPI-113, WPI-116 (manufactured by Wako Pure Chemical Industries, Ltd.).

The amount of the cationic polymerization initiator in the cationically polymerizable composition is preferably 0.001% by mass to 10% by mass, and more preferably 0.01% by mass to 5.0% by mass.

The cationically polymerizable composition may be used together with a photosensitizer, if necessary. The reactivity is improved by use of the photosensitizer, and the mechanical strength and the adhesion strength of a cured material can be improved.

The photosensitizer is suitably selected depending on the purpose without any restriction. Examples thereof include a carbonyl compound, an organosulfur compound, a persulfide, a redox series compound, azo and diazo compounds, a halogen compound, and a photoreductive pigment. Specific Examples thereof include benzoin derivatives such as benzoinmethyl ether, benzoin isopropyl ether, and α,α-dimethoxy-α-phenylacetophenone; benzophenone derivatives such as benzophenone, 2,4-dichlorobenzophenone, methyl o-benzoylbenzoate, 4,4′-bis (diethylamino)benzophenone; thioxanthone derivatives such as 2-chlorothioxanthone, and 2-isopropylthioxanthone; anthraquinone derivatives such as 2-chloroanthraquinone, and 2-methylanthraquinone; acridone derivatives such as N-methylacridone, and N-butylacridone; and α,α-diethoxyacetophenone, benzyl, fluorenone, xanthone, and a uranyl compound. These may be used independently, or in combination.

Examples of the commercially available photosensitizer include ANTHRACURE UVS-1331 (manufactured by Kawasaki Kasei Chemicals, Ltd.), and KAYACURE DETX-S (manufactured by Nippon Kayaku Co., Ltd.).

### —Solvent—

The solvent is suitably selected depending on the purpose without any restriction. Examples thereof include: water; alcohols such as methanol, ethanol, isopropanol, ethylene glycol; ketones such as acetone, and methyl ethyl ketone; ethers such as tetrahydrofuran, dioxane, propylene glycol monomethyl ether acetate; dimethyl formamide; dimethyl sulfoxide, and chloroform, methylene chloride, ethyl acetate, methyl acetate, and butyl acetate. These may be used independently, or in combination.

To the cationically polymerizable composition, other additives such as an antioxidant and the like can be added, provided that they do not adversely affect the obtainable effect of the present invention.

Examples of the commercial products of the antioxidant include dibutylhydroxytoluene (BHT), IRGANOX 1010, IRGANOX 1035FF, and IRGANOX 565.

The method for applying the hydrophilic composition containing at least the cationically polymerizable monomer is suitably selected depending on the intended purpose without any restriction. Examples thereof include a method in which the crystalline polymer microporous membrane formed into a cartridge is immersed in a hydrophilic composition containing at least the cationically polymerizable monomer, and a method in which the crystalline polymer microporous membrane formed into a cartridge is coated with the hydrophilic composition containing at least the cationically polymerizable monomer.

Next, the hydrophilic composition is applied (by immersion or coating) to the crystalline polymer microporous membrane formed into a cartridge, and then the membrane is subjected to heat treatment or ultraviolet irradiation, so as to polymerize the hydrophilic composition containing at least a cationically polymerizable monomer.

When the hydrophilic composition containing at least a cationically polymerizable monomer contains the cationic thermopolymerization initiator, the hydrophilic composition is cationically polymerized by heat treatment so that the exposed surface of the crystalline polymer microporous membrane formed into a cartridge is coated with a polymer.

The temperature for the heat treatment is preferably 50° C. to 200° C., more preferably 60° C. to 180° C., and particularly preferably 70° C. to 160° C.

The duration for the heat treatment is preferably 1 minute to 120 minutes, more preferably 1 minute to 100 minutes, and even more preferably 1 minute to 80 minutes.

When the hydrophilic composition containing at least a cationically polymerizable monomer contains a cationic photopolymerization initiator, the hydrophilic composition is cationically polymerized by ultraviolet irradiation, so as to coat the exposed surface of the crystalline polymer microporous membrane formed into a cartridge with a polymer.

The irradiance conditions of ultraviolet irradiation treatment is preferably 1.0×10² mJ/cm² to 1.0×10⁵ mJ/cm², and more preferably 5.0×10² mJ/cm² to 5.0×10⁴ mJ/cm².

### —Vinyl Acetate Polymer—

The vinyl acetate polymer is suitably selected depending on the purpose without any restriction, provided that it contains a vinyl acetate monomer or a vinyl acetate oligomer.

The vinyl acetate oligomer is suitably selected depending on the purpose without any restriction, but it is preferably dimmer to 100-mer of the vinyl acetate monomer.

The vinyl acetate monomer and the vinyl acetate oligomer are suitably selected depending on the purpose without any restriction, but it is preferred that they are crosslinked with the porous membrane using a crosslinking agent after polymerization. Such crosslinkages improve the durability of the crystalline polymer microporous membrane.

### —Ethylene Oxide Polymer—

Ethylene oxide (also called as oxirane, 1,2-epoxyethane) forming the ethylene oxide polymer is cyclic ether having a 3-membered ring structure. It is the simplest epoxide expressed by chemical formula C₂H₄O and having a molecular weight of 44.05.

The ethylene oxide polymer is suitably selected depending on the purpose without any restriction. The ethylene oxide polymer obtained by vapor phase polymerization, in which gas containing ethylene oxide or a mist formed by atomizing a solution containing ethylene oxide is polymerized in gas phase, is preferable because the crystalline polymer microporous membrane including the inner portions is efficiently hydrophilized.

The weight average molecular weight of the ethylene oxide polymer is suitably selected depending on the purpose without any restriction. It is preferably 1.0×10⁴ to 1.0×10⁶.

### —Vinyl Compound—

The vinyl compound means a compound having a vinyl group (CH₂═CH—).

The vinyl compound has at least an unsaturated group and at least a functional group.

The functional group contained in the vinyl compound is suitably selected depending on the purpose without any restriction. Examples thereof include an epoxy group, a hydroxyl group, and amino group, a carboxyl group, and derivatives thereof.

Among them, an epoxy group, a hydroxyl group, and amino group are preferable, in terms of high reactivity with the functional compound, and high acid resistance and alkali resistance of the binding site formed after reaction.

Examples of the vinyl compound having at least an unsaturated group and at least a functional group include allyl glycidyl ether, acrylic acid, methacrylic acid, 4-vinylpyridine, 2-vinylpyridine, styrene sulfonic acid, vinyl sulfonic acid, diallylamine, N,N-dimethyl diallylamine, allylamine, vinylbenzylamine, allyl alcohol. These may be used independently, or in combination.

Among them, allyl glycidyl ether is preferable because it can react by addition react with a functional compound. Styrene sulfonic acid, and vinyl sulfonic acid are particularly preferable, because they can provide high hydrophilicity, acid resistance, alkali resistance, chemical resistance to the resulting crystalline polymer microporous membrane.

However, it is preferred that the vinyl compound be not acrylate, methacrylate, acrylamide, metahcrilamide, or derivatives thereof.

As described above, since at least part of a surface of the crystalline polymer microporous membrane formed into a cartridge has been subjected to surface modification using a surface modifying agent, the crystalline polymer microporous membrane enables to have a characteristic asymmetric pore structure as well as to have hydrophilicity, and thus the filtration life time thereof is further improved. This is probably because of a unique asymmetric pore structure of the crystalline polymer microporous membrane, in which the crystalline polymer coated with the surface modifying agent is applied thicker at the portion closer to the fine filtering portion of the second surface (the heated surface) than at the portion closer to the coarse filtering part of the first surface (the unheated surface), the average pore diameter is continuously change from the first surface to the second surface, and the degree of the change in the average pore diameter is increased from the first surface to the second surface.

This is clear from the fact that the following relationship is satisfied.

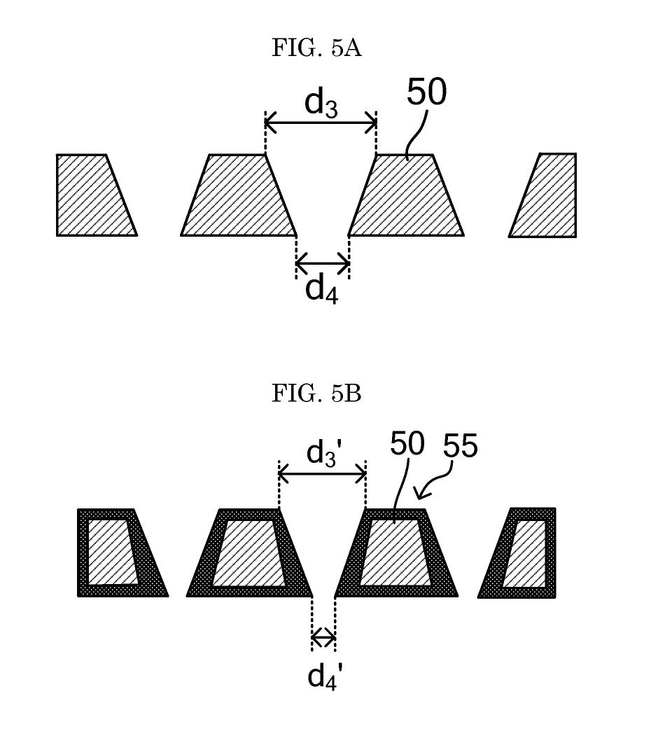

As shown in FIG. 5A, the average pore diameter of the first surface of the crystalline microporous polymer membrane formed into a cartridge before being covered with the surface modifying agent is defined as d₃, the average pore diameter of the second surface of the crystalline polymer microporous membrane formed into a cartridge before being covered with the surface modifying agent is defined as d₄, and a ratio of d₃ to d₄ is expressed by d₃/d₄.

As shown in FIG. 5B, the average pore diameter of the first surface of the crystalline polymer microporous membrane formed into a cartridge after being covered with the surface modifying agent (after hydrohylization) is defined as d₃′, the average pore diameter of the second surface of the crystalline polymer microporous membrane formed into a cartridge after being covered with the surface modifying agent is defined as d₄′, and a ratio of d₃′ to d₄′ is expressed by d₃′/d₄′. Here, the crystalline polymer microporous membrane formed into a cartridge preferably satisfies (d₃′/d₄′)/(d₃/d₄)>1, more preferably (d₃′/d₄′)/(d₃/d₄)>1.005, and even more preferably (d₃′/d₄′)/(d₃/d₄)>1.01. When the crystalline polymer microporous membrane does not satisfy (d₃′/d₄′)/(d₃/d₄)>1, namely the relationship of the aforementioned ratios is (d₃′/d₄′)/(d₃/d₄)≦1, such crystalline polymer microporous membrane has a extremely short filtration lifetime due to clogging or the like.

The filtration filter of the present invention is capable of filtration at least at a rate of 5 mL/cm²·min or higher, when the filtration is carried out at a differential pressure of 0.1 kg/cm².

Also, since the filtration filter of the present invention has a large specific surface area, fine particles introduced from its front surface can be removed by adsorption and/or adhesion before reaching a portion with the smallest pore diameter. Therefore, the filter hardly allows clogging to arise and can sustain high filtration efficiency for a long period of time.

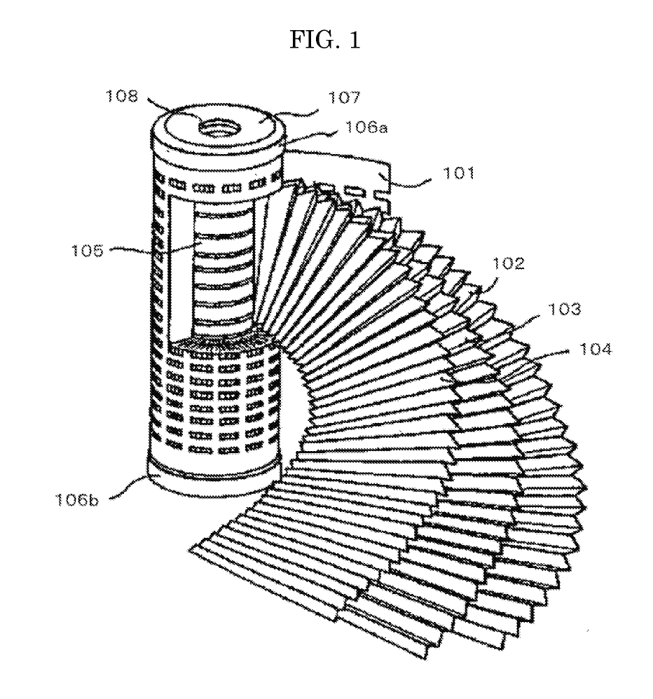

FIG. 1 is a developed view showing the structure of an element exchange type pleated cartridge element. Sandwiched between two membrane supports 102 and 104, a microfiltration membrane 103 is corrugated and wound around a core 105 having multiple liquid-collecting slots, and a cylindrical object is thus formed. An outer circumferential cover 101 is provided outside the foregoing members so as to protect the microfiltration membrane. At both ends of the cylindrical object, the microfiltration membrane is sealed with end plates 106a and 106b. The end plates are connected to a sealing portion of a filter housing (not shown), with a gasket 107 placed in between. A filtered liquid is collected through the liquid-collecting slots of the core and discharged from a fluid outlet 108.

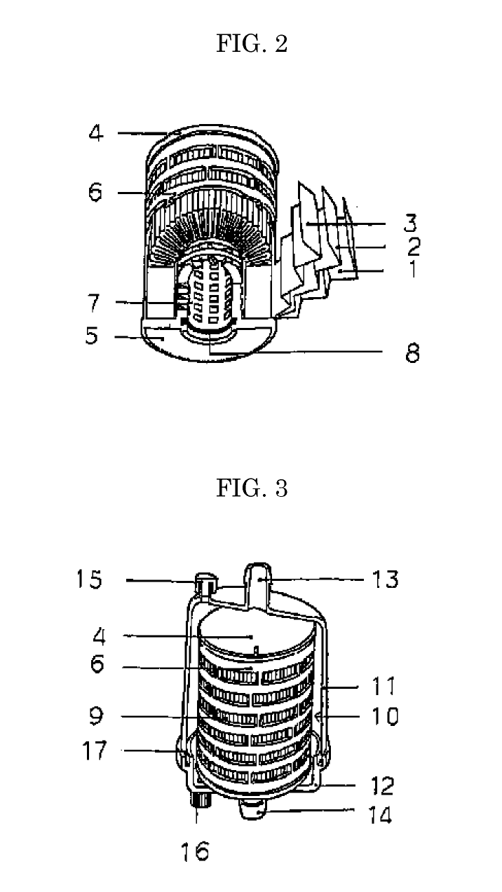

Capsule-type pleated cartridges are shown in FIGS. 2 and 3.

FIG. 2 is a developed view showing the overall structure of a microfiltration membrane filter element before installed in a housing of a capsule-type cartridge. Sandwiched between two supports 1 and 3, a microfiltration membrane 2 is corrugated and wound around a filter element core 7 having multiple liquid-collecting slots, and a cylindrical object is thus formed. A filter element cover 6 is provided outside the foregoing members so as to protect the microfiltration membrane. At both ends of the cylindrical object, the microfiltration membrane 2 is sealed with an upper end plate 4 and a lower end plate 5.

FIG. 3 shows the structure of a capsule-type pleated cartridge in which the filter element 10 has been installed in a housing so as to form a single unit. A filter element 10 is installed in a housing composed of a housing base 12 and a housing cover 11. The lower end plate is connected in a sealed manner to a water-collecting tube (not shown) at the center of the housing base 12 by means of an O-shaped ring 8. An air vent 15 is provided at the upper portion of the housing, and a drain 16 is provided at the bottom portion of the housing. A liquid enters the housing from a liquid inlet nozzle 13 and passes through a filter medium 9, then the liquid is collected through the liquid-collecting slots of the filter element core 7 and discharged from a liquid outlet nozzle 14. In general, the housing base 12 and the housing cover 11 are thermally fused in a liquid-tight manner at a fusing portion 17.

FIG. 2 shows an instance where the lower end plate 5 and the housing base 12 are connected in a sealed manner by means of the O-shaped ring 8. It should be noted that the lower end plate 5 and the housing base 12 may be connected in a sealed manner by thermal fusing or with an adhesive. Also, the housing base 12 and the housing cover 11 may be connected in a sealed manner with an adhesive as well as by thermal fusing. FIGS. 1 to 3 show specific examples of microfiltration cartridges, and note that the present invention is not confined to the examples shown in these drawings.

Having a high filtering function and long lifetime as described above, the filtration filter of the present invention enables a filtration device to be compact. In a conventional filtration device, multiple filtration units are used in parallel so as to offset the short filtration life; use of the filter of the present invention for filtration makes it possible to greatly reduce the number of filtration units used in parallel. Furthermore, since it is possible to greatly lengthen the period of time for which the filter can be used without replacement, it is possible to cut costs and time necessary for maintenance.

### —Application—

The filtration filter of the present invention can be used in a variety of situations where filtration is required, notably in microfiltration of gases, liquids, etc. For instance, the filter can be used for filtration of corrosive gases and gases for use in the semiconductor industry, and filtration and sterilization of cleaning water for use in the electronics industry, water for medical uses, water for pharmaceutical production processes and water for foods and drinks. It should be particularly noted that since the filtration filter of the present invention is superior in heat resistance and chemical resistance, the filtration filter can be effectively used for high-temperature filtration and filtration of reactive chemicals, for which conventional filters cannot be suitably used.

### EXAMPLES

Examples of the present invention will be explained hereinafter, but these examples shall not be construed as limiting the scope of the present invention.

### Synthesis Example 1

An addition reaction was initiated and proceeded using A-1420 manufactured by Daikin Chemical Sales Ltd. (F(CF₂)₄—CH₂CH₂OH) and ethylene oxide (C₂H₄O) in the manner as described in S. M. Heilmann et al., J. Fluorine Chem, 59, 1992, 387-396 to thereby obtain a fluorosurfactant expressed by the following structural formula 1. The compound expressed by the structural formula 1 had a rate of hydrophilic group substitution of 28.9%.

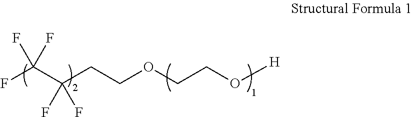

### Example 1

### Production of Cartridge 1

### —Preparation of Semi-Baked Film—

To 100 parts by mass of polytetrafluoroethylene fine powder having a number average molecular weight of 6,200,000 (POLYFLON fine powder F104U, manufactured by DAIKIN INDUSTRIES, LTD.), 27 parts by mass of hydrocarbon oil (ISOPAR manufactured by Esso Sekiyu K. K.) was added as an extrusion aid, and the obtained paste was extruded in the shape of a rod. The extruded paste was subjected to calendering at the speed of 50 m/min. by a calender roller heated at 70° C. to thereby prepare a polytetrafluoroethylene film. This film was then placed in a hot air drying oven having the temperature of 250° C. to dry and remove the extrusion aid, to thereby prepare an unbaked polytetrafluoroethylene film having an average thickness of 100 μm, average width of 150 mm, and specific gravity of 1.55.

A surface (a heating surface) of the obtained unbaked polytetrafluoroethylene film was heated by a roller (surface material: SUS316) heated at 345° C. for 1 minute, to thereby prepare a semi-baked film.

### —Production of Crystalline Polymer Microporous Membrane 1

The obtained semi-baked film was then drawn in the length direction by 12.5 times at the temperature of 270° C., then the drawn film was wound up with a winding roller. Thereafter, the film was pre-heated at 305° C., following by being drawn in the width direction by 30 times at the temperature of 270° C. with both ends thereof be pinched by clips. The drawn film was then heat set at 380° C. The extension rate of the drawn film was 260 times in terms of the area. Thus, a crystalline polymer microporous membrane 1 was produced.

### —Formation of Cartridge 1—

The crystalline polymer microporous membrane 1 was placed in between two pieces of polypropylene nonwoven fabrics, pleated so as to have a pleat width of 10.5 mm, and provided with 138 folds and formed into a cylindrical shape. The joint was fused using an impulse sealer so as to form a cylindrical object. Both ends of the cylindrical object were cut by 2 mm each, and the cut surfaces were thermally fused with polypropylene end plates so as to prepare an element exchange type cartridge 1.

### —Hydrophilization of Cartridge—

In a methanol solution containing 5% by mass of fluorosurfactant expressed by the structural formula 1 obtained in Synthesis Example 1 and 0.5% by mass of an epoxy compound (DENACOL EX411, manufactured by Nagase ChemiteX Corporation), 0.3% by mass of pentaethylenehexamine (manufactured by TOKYO CHEMICAL INDUSTRY CO., LTD.) and 0.03% by mass of DBU (manufactured by Wako Pure Chemical Industries, Ltd.), the cartridge 1 was immersed for 10 minutes, and then the cartridge 1 was taken out from the solution and subjected to annealing for 30 minutes at 100° C. in atmospheric air. Thereafter, the processed cartridge 1 was immersed in water for 30 minutes and then immersed in methanol for 30 minutes to carry out washing, and then dried, to thereby produce a surface treated cartridge 1.

### Example 2

### Production of Cartridge 2

A surface treated cartridge 2 of Example 2 was produced in the same manner as in Example 1, except that the hydrophilization treatment was changed as follows.

### —Hydrophilization of Cartridge—

In a methanol solution containing 5% by mass of pentaethylene hexamine (manufactured by Wako Pure Chemical Industries, Ltd.) and 1% by mass of an epoxy compound (DENACOL EX411, manufactured by Nagase ChemiteX Corporation), 2.5% by mass of hydroxyethylenediamine triacetic acid (manufactured by DOJINDO LABORATORIES) and 1.0% by mass of DBU (manufactured by Wako Pure Chemical Industries, Ltd.), the cartridge 1 was immersed for 10 minutes, and then the cartridge 1 was taken out from the solution and subjected to annealing for 30 minutes at 100° C. in atmospheric air. Thereafter, the processed cartridge 1 was immersed in water for 30 minutes and then immersed in methanol for 30 minutes to carry out washing, and then dried, to thereby produce a surface treated cartridge 2.

### Example 3

### Production of Cartridge 3

A surface treated cartridge 3 of Example 3 was produced in the same manner as in Example 1, except that the hydrophilization treatment was changed as follows.

### —Hydrophilization of Cartridge—

In a methanol/water mixture solution (a mass ratio of methanol: water=90% by mass: 10% by mass) containing 20% by mass of an epoxy compound (DENACOL EX411, manufactured by Nagase ChemiteX Corporation), 1.0% by mass of hydroxyethylenediamine triacetic acid (manufactured by DOJINDO LABORATORIES) as a functional compound, 1.0% by mass of a cationic polymerization initiator (SI100, manufactured by SANSHIN CHEMICAL INDUSTRY CO., LTD.), the cartridge 1 was immersed for 10 minutes, and then the cartridge 1 was taken out from the solution and subjected to annealing for 30 minutes at 150° C. in atmospheric air. Thereafter, the processed cartridge 1 was immersed in methanol for 30 minutes to carry out washing, and then dried, to thereby produce a surface treated cartridge 3.

### Example 4

### Production of Cartridge 4

A surface treated cartridge 4 of Example 4 was produced in the same manner as in Example 1, except that the hydrophilization treatment was changed as follows.

### —Hydrophilization of Cartridge—

In aqueous solution containing 1.0% by mass (concentration) of polyvinyl alcohol (PVA) (RS2117, manufactured by KURARAY CO., LTD.), the cartridge 1 in which ethanol had been impregnated was immersed, and then the cartridge was taken out from the solution, followed by immersing in a 0.20% by mass of a KOH aqueous solution containing 2.0% by mass of ethylene glycol diglycidyl ether as a crosslinking agent, and subjected to annealing for 10 minutes at 150° C. in atmospheric air. Thereafter, the processed cartridge was immersed in boiling water for 30 minutes to carry out washing, and then dried, to thereby produce a surface treated cartridge 4.

### Example 5

### Production of Cartridge 5

A surface treated cartridge 5 of Example 5 was produced in the same manner as in Example 1, except that the hydrophilization treatment was changed as follows.

—Hydrophilization of Cartridge—

While a gas mixture of nitrogen and ethylene oxide (a volume ratio of nitrogen to ethylene oxide was 100:1) was continuously introduced to the cartridge 1 in vacuum, the cartridge was irradiated with glow plasma at irradiation energy of 5.0 J/cm².

### Example 6

### Production of Cartridge 6

A surface treated cartridge 6 of Example 6 was produced in the same manner as in Example 1, except that the hydrophilization treatment was changed as follows.

### —Hydrophilization of Cartridge—

In a methanol solution containing 5% by mass of a vinyl acetate monomer purified by distillation and 0.1% by mass of α,α′-azobisisobutyronitrile (manufactured by JUNSEI CHEMICAL CO., LTD.), the cartridge 1 was immersed, and then the cartridge was taken out from the solution, and subjected to annealing for 2 hours at 60° C. in atmospheric air. Thereafter, the processed cartridge 1 was immersed in methanol for 30 minutes to carry out washing, and dried, followed by being immersed in an aqueous sodium hydroxide solution for 1 hour to carry out saponification to thereby produce a surface treated cartridge 6.

### Example 7

### Production of Cartridge 7

A surface treated cartridge 7 of Example 7 was produced in the same manner as in Example 1, except that the hydrophilization treatment was changed as follows.

### —Hydrophilization of Cartridge—

In a methanol solution containing 5.0% by mass of allyl glycidyl ether (manufactured by TOKYO CHEMICAL INDUSTRY CO., LTD.) and 0.1% by mass of IRGACURE 907 (manufactured by CIBA Specialty Chemicals Ltd.) as a photopolymerization initiator, the cartridge 1 was immersed for 10 minutes, and then the cartridge was taken out from the solution, and subjected to UV curable treatment at irradiation intensity of 40 mW/cm² for 90 seconds. Thereafter, the processed cartridge 1 was immersed in methanol for 30 minutes to carry out washing, and dried, followed by being immersed in an aqueous solution of 1% by mass of hydroxyethylenediamine triacetic acid, manufactured by DOJINDO LABORATORIES) and then the cartridge was taken out from the solution, and subjected to annealing for 10 minutes at 150° C. in atmospheric air. Thereafter, the processed cartridge was immersed in methanol for 30 minutes to carry out washing, and dried to thereby produce a surface treated cartridge 7.

### Comparative Example 1

### Production of Cartridge 8

A cartridge 8 whose surface was not treated of Comparative Example 1, which was formed of polytetrafluoroethylene and had an asymmetric pore structure, was produced in the same manner as in Example 1, except that the hydrophilization was not performed.

### Comparative Example 2

### Production of Cartridge 9

A surface treated cartridge 9 of Comparative Example 2 was produced in the same manner as in Example 1, except that the annealing for 30 minutes at 100° C. was change to hydrophilic treatment using γ line (irradiation dose 10 Mrad).

### Comparative Example 3

### Production of Cartridge 10

A surface treated cartridge 10 of Comparative Example 3 was produced in the same manner as in Example 1, except that a polytetrafluoroethylene microporous membrane (symmetric membrane, pore diameter: 3 μm, manufactured by Japan Gore-Tex Inc.) was used.

### <Measurement of Average Pore Diameter and Evaluation of Shape of Pores>

The crystalline polymer microporous membranes formed into cartridges of Examples 1 to 7 and Comparative Examples 1 to 3 were each cut along the length direction of the membrane. A photograph (a SEM photograph, magnification of 1,000 times to 5,000 times) of the membrane surface, which was the cut surface of the membrane in the thickness direction, was taken by a scanning electron microscope (HITACHI S-4000, HITACHI E-1030 for vapor deposition, both manufactured by Hitachi, Ltd.). The obtained photograph was scanned by an image processer (Device: TV Image Processer TVIP-4100II, manufactured by Nippon Avionics Co., Ltd., Control Software: TV Image Processer Image Command 4198, manufactured by RATOC SYSTEM ENGINEERING CO., LTD.), to thereby obtain an image only consisted of crystalline polymer fibers. Diameters of 100 pores were measured on the obtained image, and were arithmetic processed to determine an average pore diameter.

Shapes of pores on the cut surface of the crystalline polymer microporous membrane formed into cartridges in the thickness direction thereof are explained with reference with schematic drawings for more understanding.

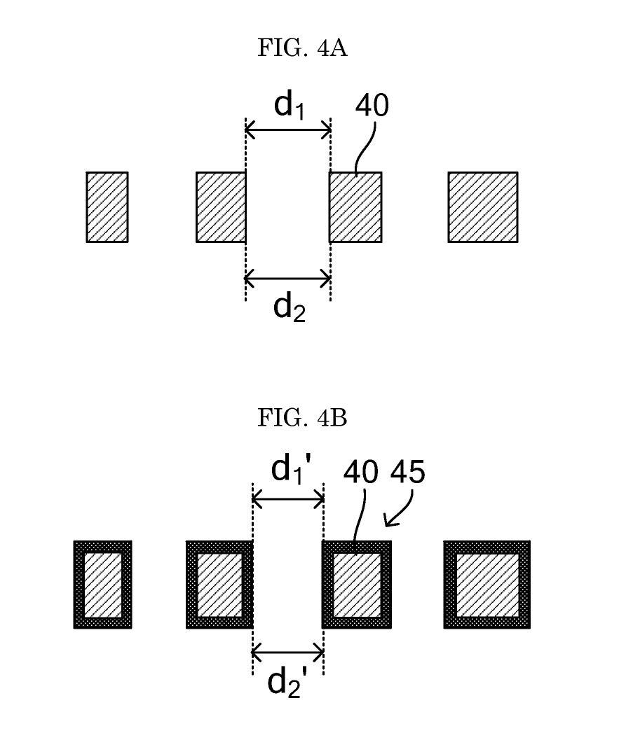

FIG. 4A is a schematic diagram showing a cut surface of the crystalline polymer microporous membrane 40 having symmetric pores of Comparative Example 3 before being covered with the fluorosurfactant (before hydrophilization).

Comparing the average pore diameter d₁ on the first surface of the crystalline polymer microporous membrane 40 having the symmetric pores before being covered with the fluorosurfactant (before hydrophilization) with the average pore diameter d₂ on the second surface thereof in FIG. 4A, the ratio (d₁/d₂) of d₁ to d₂ on the observed SEM was 1.0.

FIG. 4B is a schematic diagram showing a cut surface of the crystalline polymer microporous membrane 45 having symmetric pores of Comparative Example 3 after being covered with the fluorosurfactant (after hydrophilization).

Comparing the average pore diameter d₁′ on the first surface of the crystalline polymer microporous membrane 45 having the symmetric pores after being covered with the fluorosurfactant (after hydrophilization) with the average pore diameter d₂′ on the second surface thereof in FIG. 4B, the ratio (d₁′/d₂′) of d₁′ to d₂′ on the observed SEM was 1.0.

In Comparative Example 3, the relationship of (d₁′/d₂′)/(d₁/d₂) was 1.0. Based on above, it was found that the crystalline polymer microporous membrane having symmetric pores of Comparative Example 3 which had not been subjected to asymmetric heating did not have any change both in the ratio (d₁/d₂) and the ratio (d₁′/d₂′) before and after being covered with the fluorosurfactant (hydrophilization).

FIG. 5A is a schematic diagram showing a cut surface of the crystalline polymer microporous membrane 50 having asymmetric pores of Example 1 before being covered with the fluorosurfactant (before hydrophilization).

When the average pore diameter on the first surface of the crystalline polymer microporous membrane 50 having the asymmetric pores before being covered with the fluorosurfactant (before hydrophilization) was determined as d₃, and the average pore diameter on the second surface thereof was determined as d₄ in FIG. 5A, the ratio (d₃/d₄) of d₃ to d₄ on the observed SEM was 15.

FIG. 5B is a schematic diagram showing a cut surface of the crystalline polymer microporous membrane 55 having asymmetric pores of Example 1 after being covered with the fluorosurfactant (after hydrophilization).

When the average pore diameter on the first surface of the crystalline polymer microporous membrane 55 having the asymmetric pores after being covered with the fluorosurfactant (after hydrophilization) was determined as d₃′, and the average pore diameter on the second surface thereof was determined as d₄′ in FIG. 5B, the ratio (d₃′/d₄′) of d₃′ to d₄′ on the observed SEM was 16.5.

Therefore, in Example 1, the value of (d₃′/d₄′)/(d₃/d₄) was 1.1.

Based on the comparison between the ratio (d₃′/d₄′) of the crystalline polymer microporous membrane of Example 1 after being covered with the fluorosurfactant and the ratio (d₃/d₄) of the crystalline polymer microporous membrane thereof before being covered with the fluorosurfactant, it was found that the ratio of the average pore diameter of the first surface (unheated surface) to the average pore diameter of the second surface (heated surface) was increased as a result of coverage with the fluorosurfactant (hydrophilization).

This result had not been expected before the observation of the SEM image, and this result was attained, since in addition to that the average pore diameter of the crystalline polymer microporous membrane 50 continuously changed from the first surface to the second surface, the thickness of the hydrophilic covering portion after hydrophilization using the fluorosurfactant continuously changed and gradually increased from the first surface to the second surface. The crystalline polymer covered with the fluorosurfactant became thicker than the course filtering portion at the side of the first surface (unheated surface) of the crystalline polymer microporous membrane, as it was closer to the fine portion at the side of the second surface (heated surface) thereof, and thus a significant asymmetric pore structure, in which the degree of the continuous change in the average pore diameter from the first surface to the second surface was enlarged, could be formed.

Based on the result described above, it was made clear that the crystalline polymer microporous membrane formed into a cartridge of Example 1 had high hydrophilicity and could significantly prolong a lifetime as a filtration filter (filtration rate), which would be ended by clogging, because the ratio of the average pore diameter of the first surface to the average pore diameter of the second surface was large.

Similarly, in Example 2, the asymmetric membrane having d₃/d₄₌₁₅ had d₃′/d_{4′=15.9} after hydrophilization, and therefore (d₃′/d₄′)/(d₃/d₄)=1.06.

Similarly, in Example 3, the asymmetric membrane having d₃/d₄₌₁₅ had d₃′/d_{4′=18.5} after hydrophilization, and therefore (d₃′/d₄′)/(d₃/d₄)=1.23.

Similarly, in Example 4, the asymmetric membrane having d₃/d₄₌₁₅ had d₃′/d_{4′=18} after hydrophilization, and therefore (d₃′/d₄′)/(d₃/d₄)=1.2.

Similarly, in Example 5, the asymmetric membrane having d₃/d₄₌₁₅ had d₃′/d_{4′=15.9} after hydrophilization, and therefore (d₃′/d₄′)/(d₃/d₄)=1.06.

Similarly, in Example 6, the asymmetric membrane having d₃/d₄₌₁₅ had d₃′/d_{4′=15.6} after hydrophilization, and therefore (d₃′/d₄′)/(d₃/d₄)=1.04.

Similarly, in Example 7, the asymmetric membrane having d₃/d₄₌₁₅ had d₃′/d_{4′=16.9} after hydrophilization, and therefore (d₃′/d₄′)/(d₃/d₄)=1.13.

In Comparative Example 1, the asymmetric membrane having d₃/d₄₌₁₅ was not subjected to hydrophilization, and thus the average pore diameter was not changed.

In Comparative Example 2, the asymmetric membrane having d₃/d₄₌₁₅ had d₃′/d_{4′=16.2} after hydrophilization, and therefore (d₃′/d₄′)/(d₃/d₄)=1.08.

These results are shown in Table 1.

### <Evaluation on Hydrophilicity>

The crystalline polymer microporous membrane was taken out from each of the cartridges of Examples 1 to 7 and Comparative Examples 1 to 3, and evaluated in terms of hydrophilicity.

The evaluation for hydrophilicity was carried out with reference to the evaluation method disclosed in Japanese Patent (JP-B) No. 3075421. Specifically, the initial hydrophilicity was evaluated in the following manner.

A droplet of water was dropped onto a surface of a sample from the height of 5 cm, and the time required for the sample to absorb the droplet was measured. The measurement results were evaluated based on the evaluation criteria presented below. The results are shown in Table 1.

A: Absorbed immediately.

B: Naturally absorbed.

C: Absorbed only when pressure was applied, or not absorbed though the contact angle was reduced.

D: Not absorbed, i.e. repelling water.

Note that, the state of D is one of characteristics of a porous fluororesin material.

### <Filtering Test>

A filtering test was performed on the cartridges of Examples 1 to 7, and Comparative Examples 1 to 3. A test solution containing 0.01% by mass of polystyrene latex (average particle size of 1.5 μm) was filtered through each of the membranes of Examples 1 to 7, and Comparative Examples 1 to 3, with a differential pressure of 10 kPa, and an amount of the solution filtered until the filter was clogged was measured. The results are shown in Table 1.

TABLE 1

| | | Filtering Test | (d₁′/d₂′)/ | |
|---|---|---|---|---|
| | Hydrophilicity | (mL/cm²) | (d₁/d₂) | (d₃′/d₄′)/(d₃/d₄) |
| Example 1 | A | 236 | — | 1.1 |
| Example 2 | A | 201 | — | 1.06 |
| Example 3 | A | 182 | — | 1.23 |
| Example 4 | A | 196 | — | 1.2 |
| Example 5 | A | 222 | — | 1.06 |
| Example 6 | A | 209 | — | 1.04 |
| Example 7 | A | 199 | — | 1.13 |
| Comparative | D | Could not be | — | — |
| Example 1 | | measured | | |
| Comparative | C | 23 | — | 1.08 |
| Example 2 | | | | |
| Comparative | A | 68 | 1.0 | 1 |
| Example 3 | | | | |

Based on the results shown in Table 1, it could be seen that the crystalline polymer microporous membranes of Examples 1 to 7 and Comparative Example 3 were hydrophilic, and that the crystalline polymer microporous membranes of Comparative Example 1 showed no hydrophilicity at all. In the filtering test, as the PTFE microporous membranes of Comparative Example 1 did not have any hydrophilicity, and thus the measurement could not be performed. In addition, the membrane of Comparative Examples 2 and 3 did not exceed 100 mL/cm².

On the other hand, the crystalline polymer microporous membranes of Examples 1 to 7 each required no pretreatment of hydrophilization with isopropanol which had been conventionally needed, and could filter through the test solution of 100 mL/cm² or more.

### <Evaluation on Water Resistance>

Water (200 mL) was passed through each of the cartridges of Examples 1 to 7, and Comparative Examples 1 to 3 at the pressure of 100 kPa. This process was carried out 5 times, and the membrane was dried every time water was passed through the membrane.

Water resistance of the cartridges of Examples 1 to 7, and Comparative Examples 1 to 3 were each evaluated by evaluating the membranes after the aforementioned procedure based on the evaluation criteria (A to D) used for the evaluation for the hydrophilicity. The results are shown in Table 2.

### <Evaluation on Acid Resistance>

Acid resistance of each of the cartridges of Examples 1 to 7, and Comparative Examples 1 to 3 was evaluated by immersing each membrane in a 1N aqueous hydrochloric acid solution having the temperature of 80° C. for 5 hours, then evaluating the membrane based on the evaluation criteria (A to D) used for the evaluation for the hydrophilicity. The results are shown in Table 2.

### <Evaluation on Alkali Resistance>

Alkali resistance of each of the cartridges of Examples 1 to 7, and Comparative Examples 1 to 3 was evaluated by immersing each membrane in a 1N aqueous sodium hydroxide solution having the temperature of 80° C. for 5 hours, then evaluating the membrane based on the evaluation criteria (A to D) used for the evaluation for the hydrophilicity. The results are shown in Table 2 below.

### <Evaluation on Chemical Resistance>

Chemical Resistance of each of the cartridges of Examples 1 to 7 and Comparative Examples 1 to 3 was evaluated by immersing each membrane in a methanol solution for 1 hour, then evaluating the membrane based on the evaluation criteria (A to D) used for the evaluation for the hydrophilicity. The results are shown in Table 2 below.

TABLE 2

| | Water | Acid | Alkali | Chemical |
|---|---|---|---|---|
| | Resistance | Resistance | Resistance | Resistance |
| Example 1 | A | A | A | A |
| Example 2 | A | A | A | A |
| Example 3 | A | A | A | A |
| Example 4 | A | A | A | A |
| Example 5 | A | A | A | A |
| Example 6 | A | A | A | A |
| Example 7 | A | A | A | A |
| Comparative | NA | NA | NA | NA |
| Example 1 | | | | |
| Comparative | C | C | C | C |
| Example 2 | | | | |
| Comparative | A | A | A | A |
| Example 3 | | | | |

Note that, in Table 2, “NA” means that the evaluation could not be carried out because of poor hydrophilicity.

Since the filtration filter of the present invention is obtained by surface treatment of a crystalline polymer microporous membrane which has been formed into the cartridge, so as to secure porosity, and have high water resistance, high acid resistance, high alkali resistance, high heat resistance and chemical resistance, so that they can be used in a variety of situations where filtration is required, notably in microfiltration of gases, liquids, etc. For instance, the cartridge can be widely used for filtration of corrosive gases and gases for use in the semiconductor industry, filtration and sterilization of cleaning water for use in the electronics industry, water for medical uses, water for pharmaceutical production processes and water for foods and drinks, high-temperature filtration and filtration of reactive chemicals.

What is claimed is:

1. A filtration filter comprising:
a cartridge, which comprises
a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof,
wherein at least part of the crystalline polymer microporous membrane forming the cartridge is subjected to surface modification after the crystalline polymer microporous membrane is formed into the cartridge.

2. The filtration filter according to claim 1, further comprising any one of a crosslinking material and a polymer material, which covers at least part of the crystalline polymer microporous membrane for the surface modification.

3. The filtration filter according to claim 2, wherein the crosslinking material is one selected from the group consisting of a hydrophilic polymer, a surfactant, polyhydric alcohol, polyamine and fluorine alcohol.

4. The filtration filter according to claim 3, wherein the crosslinking material is crosslinked using a crosslinking agent.

5. The filtration filter according to claim 2, wherein the polymer material is one selected from the group consisting of a cationic polymer, a vinyl acetate polymer, an ethylene oxide polymer, and a vinyl compound.

6. The filtration filter according to claim 1, wherein the crystalline polymer microporous membrane satisfies: (d₃′/d₄′)/(d₃/d₄)>1, where d₃ and d₄ respectively denote the average pore diameter of the first surface of the crystalline polymer microporous membrane formed into the cartridge before surface modification, and the average pore diameter of the second surface of the crystalline polymer microporous membrane formed into the cartridge before surface modification, d₃′ and d₄′ respectively denote the average pore diameter of the first surface of the crystalline polymer microporous membrane formed into the cartridge after surface modification, and the average pore diameter of the second surface of the crystalline polymer microporous membrane formed into the cartridge after surface modification, d₃/d₄ expresses a ratio of d₃ to d₄, and d₃′/d₄′ expresses a ratio of d₃′ to d₄′.

7. The filtration filter according to claim 1, wherein the crystalline polymer microporous membrane contains a crystalline polymer, which is polytetrafluoroethylene.

8. The filtration filter according to claim 1, wherein the cartridge is a pleated cartridge.

9. A method for producing a filtration filter comprising:
forming a crystalline polymer microporous membrane having a plurality of pores, where the average pore diameter of a first surface of the crystalline polymer microporous membrane is larger than that of a second surface thereof, and the average pore diameter of the crystalline polymer microporous membrane continuously changes from the first surface thereof to the second surface thereof;
forming the crystalline polymer microporous membrane into a cartridge; and
subjecting at least part of the crystalline polymer microporous membrane formed into the cartridge to surface modification.

10. The method for producing a filtration filter according to claim 9, wherein the cartridge is a pleated cartridge.

11. The method for producing a filtration filter according to claim 9, wherein the surface modification contains covering at least part of the crystalline polymer microporous membrane with any one of a crosslinking material and a polymer material.

12. The method for producing a filtration filter according to claim 9, wherein the crystalline polymer microporous membrane contains a crystalline polymer, which is polytetrafluoroethylene.
